(19) United States
(12) Patent Application Publication
(10) Pub. No.: US 2005/0103029 A1
(43) Pub. Date: May 19, 2005

(54) Refrigerator having alarm device for alarming leakage of refrigerant

(76) Inventors: Keizou Kawahara, Shiga (JP); Shigeto Yoshida, Shiga (JP); Masayuki Tsutsumi, Shiga (JP); Daisuke Sakura, Shiga (JP); Akinobu Nagara, Shiga (JP); Yoshiko Akitomo, Shiga (JP); Noriko Takahashi, Shiga (JP); Naonobu Oda, Aichi (JP); Kazumoto Imai, Aichi (JP); Kunio Takeuchi, Aichi (JP); Hiroshi Nagano, Aichi (JP); Hisato Kobayashi, Shiga (JP); Keiji Mori, Tokyo (JP); Yasuhisa Fujita, Osaka (JP)

Correspondence Address: MORRISON & FOERSTER LLP, 1650 TYSONS BOULEVARD, SUITE 300, MCLEAN, VA, 22102, US

(21) Appl. No.: 10/501,489

(22) PCT Filed: Dec. 27, 2002
(86) PCT No.: PCT/JP02/13836

(30) Foreign Application Priority Data
Jan. 15, 2002 (JP) 2002-5500
Jan. 17, 2002 (JP) 2002-8309

(51) Int. Cl. F25B 49/00; G01K 13/00

(52) U.S. Cl. 62/126; 62/129

(57) ABSTRACT

A detector (29) detects that a refrigerant gas has leaked from a refrigeration cycle, or detects in advance that a refrigerant is to leak. The alarming device (27) gives users an alarming signal warning against the refrigerant leak. The alarming device (27) is caused to stop giving an alarming signal after users open doors of storage compartments including a refrigerator compartment (4), a vegetable storage compartment (5) and a freezer compartment (6). For example, after all the doors of the storage compartments are opened, giving the alarming signal is stopped. Otherwise, giving the alarming signal is stopped after the door of a storage compartment into which cold air flows by causing a damper (12) to open is opened.

### FIELD OF THE INVENTION

The present invention relates to a refrigerator comprising an alarming device for giving users an alarming signal warning against a refrigerant leak from a refrigeration cycle that has stored an inflammable refrigerant.

### BACKGROUND OF THE INVENTION

Interest in the protection of the ozone layer and the issue of global warming has grown all over the world in recent years. Accordingly, refrigerants, which are used for refrigeration cycles of refrigerators and air conditioners and the like, have been required to be improved. Nowadays, most of refrigerators in the market use hydrofluorocarbon (HFC) as a refrigerant. Since a coefficient of global warming is still high for an HFC refrigerant, however, use of a hydrocarbon (HC) refrigerant which does not deplete the ozone layer, and which has a lower coefficient of global warming, has been under consideration for a future refrigerant.

Properties of the HC refrigerant include inflammability. For this reason, refrigerators which use the HC refrigerant could be set on fire if a refrigerant leak is to occur, since the leaking HC refrigerant could be inflamed through being ignited by sparks at a contact point of electrical components such as a relay or by heat generated by a defrost heater in the refrigerators. Against this background, various measures for fire prevention have been considered.

Even if a refrigerant leak is to occur in a high pressure area of the refrigeration cycle, however, the leaking refrigerant gas would diffuse into the air within such a few minutes that the concentration of the refrigerant gas comes to be lower than the concentration of inflammation. For this reason, a risk of inflammation is small, and a degree of the safety from fire is high.

On the contrary, if a refrigerant leak is to occur in a low pressure area of the refrigeration cycle, especially around an evaporator, the leaking refrigerant gas could so suffuse a storage compartment that the concentration of the refrigerant reaches the concentration of inflammation. In this case, when users open the door of the storage compartment, the leaking refrigerant gas flow out of the compartment. If a source of ignition such as a lighter is nearby, the refrigerant gas could be inflamed by the source of ignition.

The following two measures could be considered in order to solve this problem. A first measures is to detect a leaking refrigerant gas with a gas leak sensor, or through analyzing a fluctuation in the temperature or pressure of the refrigeration cycle, and to give an alarming signal with a buzzer, sounds, a display or the like. This is to urge users to take action such as ventilate the refrigerator by opening the refrigerator door and use no fire, and accordingly this is to reduce factors of causing inflammation.

Since a refrigerant leak occurs all of a sudden, however, it is likely that users cannot deal with it with composure. For example, since a buzzer or a display makes users feel uncomfortable, some users may merely turn off the alarming device by operating the control panel and the like and may not open the door. Others may be annoyed about the buzzer and pull out the plug and the like. Against expectation, giving an alarming signal may bring users into discomposure, and may prevent users from taking adequate action. These have been problems.

These problems could be solved if refrigerators would be equipped with an automatic door opening mechanism designed to open the doors automatically when a refrigerant leak is detected. Since, however, most of large refrigerators of these days have five doors, costs could soar so high as to make it unpractical to equip all the doors with the automatic door opening mechanism.

For the purpose of reducing a risk of ignition in a compartment, a second measures is to recover a refrigerant in the low pressure area of the refrigeration cycle by causing a compressor to operate, and to circulate the air in a compartment by causing a fan to operate so as to prevent a leaking refrigerant from suffusing the bottom of the compartment and the like. This is to lower the concentration of the leaking refrigerant.

An inflammable refrigerant which is stored in the refrigeration cycle of a household refrigerator weighs as little as 50 to 100 grams. A leaking refrigerant, if in a compartment, would pour out through gaps of gaskets of the door or the drainpipe, and spread from the drain or the like to the machine compartment and the like. With the lapse of time, the leaking gas would so diffuse into the air that the concentration comes to be lower than the concentration of ignition, and a risk of fire would decrease.

If, however, an alarming signal is given with a buzzer and the like immediately after a refrigerant leaks, users may be urged to open a refrigerator door in order to let the refrigerant leaking in the compartment diffuse, while the concentration of the leaking refrigerant gas is high. If a source of ignition such as a lighter is nearby, the refrigerant gas could be inflamed by the source of ignition.

In addition, when users come close to the refrigerator to turn off the buzzer, the refrigerant gas could be ignited if the users carry a source of ignition, since the high concentrated refrigerant gas leaks from the machine compartment.

Furthermore, if users feel annoyed about the buzzer and pull out the plug, control for lowering the concentration of the leaking refrigerant could not be made.

These problems could be solved if no alarming signal is given. While in a state of a refrigerant leaking, however, refrigerators cannot run a normal operation. Accordingly, an alarming signal needs to be given in order to inform users of a trouble with refrigerators, and in order to urge users to have the refrigerators fixed.

### DISCLOSURE OF THE INVENTION

The first aspect of the present invention is a refrigerator that includes a refrigeration cycle which a compressor, a condenser, a capillary, an evaporator, and an accumulator are connected to, and in which an inflammable refrigerant is included; a detector for detecting a leak of the refrigerant; an alarming device for giving an alarming signal warning against the refrigerant leak when the refrigerant leak is detected by the detector; and a controller for causing the alarming device to stop giving an alarming signal after a door of a storage compartment is opened.

The second aspect of the present invention is a refrigerator that includes a refrigeration cycle which a compressor, a condenser, a capillary, an evaporator, and an accumulator are connected to, and in which an inflammable refrigerant is included; a duct for sending cold air which has been cooled by the evaporator to at least the storage compartments including a refrigerator compartment and a freezer compartment; a damper, which is arranged in the duct, for adjusting an amount of the cold air which is being sent; a detector for detecting a leak of the refrigerant; an alarming device for giving an alarming signal warning against the refrigerant leak when the refrigerant leak is detected by the detector; and a controller for causing the alarming device to stop giving an alarming signal after a door of a storage compartment into which the cold air flows after the damper is opened.

The third aspect of the present invention is a refrigerator that includes a refrigerating space and a freezing space which are formed in a way that the storage space in the main body of the refrigerator is sectioned off by a partition wall; a refrigeration cycle which a compressor, a condenser, capillaries and evaporators for the refrigerating space and the freezing space, and an accumulator are connected to in a way that the refrigerating space and the freezing space are capable of being controlled independently for refrigeration, and in which an inflammable refrigerant is included; a detector for detecting a refrigerant leak in each of the refrigerating space and the freezing space; an alarming device for giving an alarming signal warning against the refrigerant leak when the refrigerant leak is detected by the detector; and a controller for causing the alarming device to stop giving an alarming signal after a door of a compartment in one of the refrigerating space and the freezing compartment in which the refrigerant leak is detected by the detector is opened.

The fourth aspect of the present invention is a refrigerator that includes a refrigeration cycle which a compressor, a condenser, a capillary, an evaporator, and an accumulator are connected to, and in which an inflammable refrigerant is included; a detector for detecting a leak of the refrigerant; an alarming device for giving an alarming signal warning against the refrigerant leak after a prescribed length of time has passed in the case that the refrigerant leak is detected by the detector.

The fifth aspect of the present invention is a refrigerator that includes a refrigeration cycle which a compressor, a condenser, a capillary, an evaporator, and an accumulator are connected to, and in which an inflammable refrigerant is included; a detector for detecting a leak of the refrigerant; an alarming device for giving an alarming signal warning against the refrigerant leak when a refrigerant leak is no longer detected after the refrigerant diffuses in the case that the refrigerant leak is detected by the detector.

### BRIEF DESCRIPTION OF DRAWINGS

FIG. 1 is a vertical cross sectional view to show a structure of a refrigerator according to a first embodiment of the present invention.

FIG. 2 is a block diagram to show a constitution of a refrigeration cycle used for the refrigerator according to the first embodiment.

FIG. 3 is a diagram of a control block to show a configuration of a controller and peripherals used for the refrigerator according to the first embodiment.

FIG. 4 is a flowchart to show a flow of a set of steps from the occurrence of a refrigerant leak through the turning off of an alarming device in the refrigerator according to the first embodiment.

FIG. 5 is a vertical cross sectional view to show a structure of a refrigerator according to a second embodiment of the present invention.

FIG. 6 is a block diagram to show a constitution of a refrigeration cycle used for the refrigerator according to the second embodiment.

FIG. 7 is a diagram of a control block to show a configuration of a controller and peripherals used for the refrigerator according to the second embodiment.

FIG. 8 is a flowchart to show a flow of a set of steps from the occurrence of a refrigerant leak through the turning off of an alarming device in the refrigerator according to the second embodiment.

FIG. 9 is a flowchart to show a flow of another set of steps from the occurrence of a refrigerant leak through the turning off of an alarming device in the refrigerator according to the second embodiment.

FIG. 10 is a timed chart of steps to be taken in compliance with the flowchart of FIG. 9.

FIG. 11 is a flowchart to show a flow of yet another set of steps from the occurrence of a refrigerant leak through the turning off of an alarming device in the refrigerator according to the second embodiment.

FIG. 12 is a timed chart of steps to be taken in compliance with the flowchart of FIG. 11.

FIG. 13 is a flowchart to shown a flow of still another set of steps from the occurrence of a refrigerant leak through the turning off of an alarming device in the refrigerator according to the second embodiment.

FIG. 14 is a timed chart of steps to be taken in compliance with the flowchart of FIG. 12.

FIG. 15 is a vertical cross sectional view to show a schematic structure of a refrigerator according to a third embodiment of the present invention.

FIG. 16 is a magnified, cross sectional view to show a schematic structure of an icemaker compartment used for the refrigerator of FIG. 15.

FIG. 17 is an assemblage, perspective view to show a detailed structure of the automatic icemaker shown in FIG. 16.

FIG. 18 is a cross sectional view taken in the axial direction to show a structure of a motor, of the icemaker operator shown in FIG. 17, which has been installed into a case.

FIG. 19 is a rear view to show a structure of a motor, of the icemaker operator shown in FIG. 17, which has been installed into the case.

FIG. 20 is a front view on the side of the terminal to show a structure of a motor, of the icemaker operator shown in FIG. 17, which has been installed into the case.

FIG. 21 is a cross sectional view taken in the axial direction to show a structure in the vicinity of a motor of a water supply pump shown in FIG. 16.

FIG. 22 is a block diagram to show a constitution of a refrigeration cycle used for the refrigerator of FIG. 15.

FIG. 23 is a diagram of a control block to show a schematic configuration of the controller and peripherals used for the refrigerator of FIG. 15.

FIG. 24 is a graph to show a fluctuation in the concentration of a refrigerant inside the machine compartment caused when a leak is made in a refrigeration cycle.

FIG. 25 is a graph to show a fluctuation in the concentration of a refrigerant in the front of the machine compartment caused when a leak is made in the refrigeration cycle.

FIG. 26 is a graph to show a fluctuation in the concentration of a refrigerant inside a freezer compartment caused when a leak is made in the refrigeration cycle.

FIG. 27 is a flowchart to show timings of operations of an alarming device.

FIG. 28 is another flowchart to show timings of operations of the alarming device.

FIG. 29 is yet another flowchart to show timings of operations of the alarming device.

FIG. 30 is still another flowchart to show timings of operations of the alarming device.

### MOST PREFERABLE EMBODIMENT OF THE PRESENT INVENTION

### First Embodiment of the Present Invention

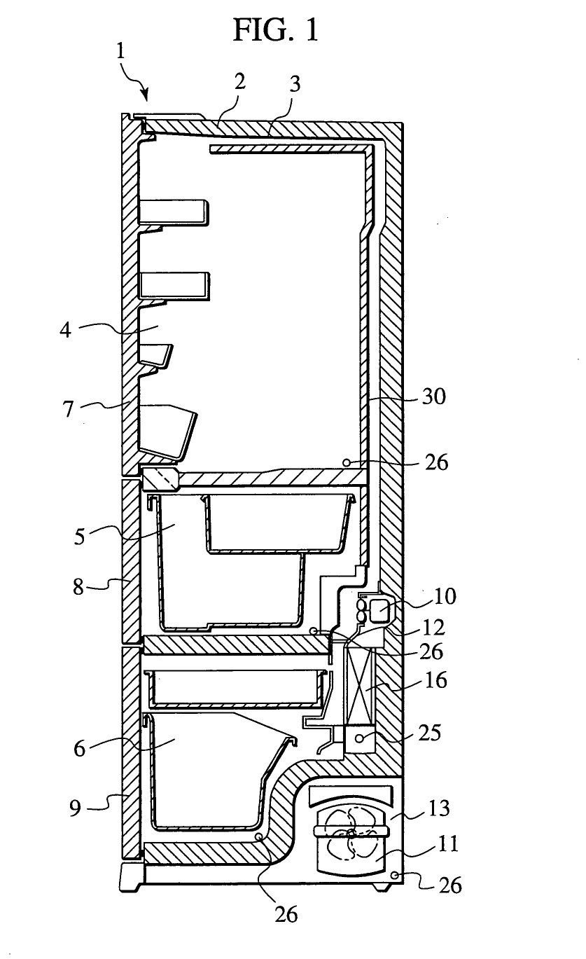

A refrigerator according to a first embodiment of the present invention will be described in detail below with reference to drawings. As shown in the cross sectional view of FIG. 1, a main body 1 of a refrigerator includes, in an insulation box 2, storage compartments such as a refrigerator compartment 4, a vegetable storage compartment 5 and a freezer compartment 6 which are sectioned off by an inner box 3. The refrigerator compartment 4, the vegetable storage compartment 5 and the freezer compartment 6 includes separated doors 7, 8 and 9 respectively. A blowing fan 10 and an evaporator 16 are arranged in the back of the vegetable storage compartment 5, and operate while being synchronized with a compressor 11. A cold air circulation duct 30 for supplying cold air to the insides of the refrigerator compartment 4 and the vegetable storage compartment 5 is arranged in the back of the refrigerator compartment 4. A damper 12 for adjusting an amount of cold air is arranged in the back of the vegetable storage compartment 5.

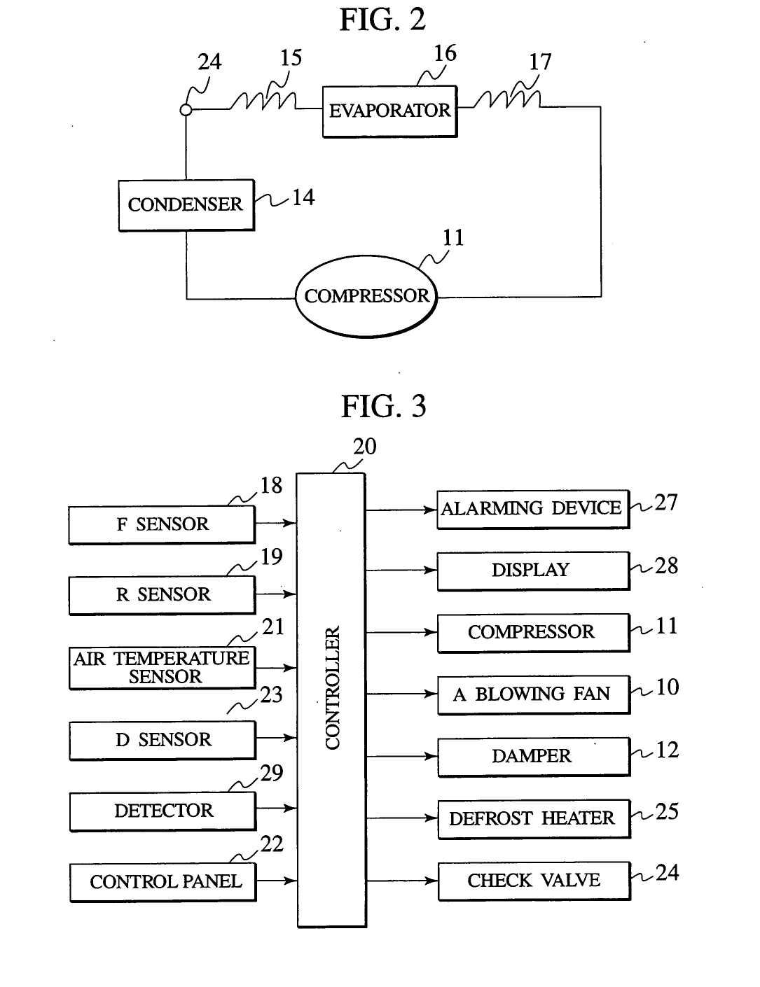

The compressor 11, which constitutes a part of a refrigeration cycle, is arranged in a machine compartment 13 that is located underneath the rear wall of the main body 1 of the refrigerator. As shown in FIG. 2, the refrigeration cycle includes the compressor 11, a condenser 14, a capillary 15 and an evaporator 16. An accumulator 17 is arranged on the side of the outlet of the evaporator 16. Inflammable HC refrigerants such as isobutane are used for the refrigeration cycle.

An HC refrigerant released from the compressor 11 flows through the condenser 14, the capillary 15, the evaporator 16 and the accumulator 17, and hereafter returns to the compressor 11. Cold air that has been refrigerated by the evaporator 16 is supplied to the refrigerator compartment 4, the vegetable storage compartment 6 and the freezer compartment 5 by the blowing fan 10, and cools down these compartments.

As shown in the diagram of the control block of FIG. 3, the freezer compartment 6 is provided with a freezer compartment sensor 18 for detecting the temperature of the freezer compartment (hereinafter referred to as an “F sensor”).

Each of refrigerator compartment 4 and the freezer compartment 6 is provided with a refrigerator compartment/vegetable storage compartment sensor 19 for detecting the temperature of each compartment (hereinafter referred to as an “R sensor”). The controller 20 causes the compressor 11 to operate and hereby cools the refrigerator compartment 4 or the vegetable storage compartment 5, when the controller determines that an output value from the R sensor 19 is higher than a prescribed temperature which has been determined in advance.

A part of cold air is supplied to the freezer compartment 6 by the blowing fan 10. Another part of cold air is supplied to the refrigerator compartment 4 and the vegetable storage compartment 5 through the cold air circulation duct 30 through the opening of the damper 12 by the controller 20. When the compartment temperatures of the refrigerator compartment 4 and the vegetable storage compartment 5 come to be lower than respective, prescribed temperatures, the controller 20 causes the damper 12 to close, and hereby halts the supply of cold air to the compartments to adjust the temperatures in the compartments. The controller 20 causes the compressor 11 to halt, when the controller determines that an output value from the F sensor 18 of the freezer compartment 6 is lower than a prescribed temperature that has been determined in advance. Later, when the temperature rises until the temperature comes to be higher than a prescribed temperature, the controller activates the compressor 11. It is preferable that the prescribed temperatures can be adjusted by an output value from an air temperature sensor 21 or through a temperature adjustment by use of a control panel 22.

In this manner, the compressor 11 repeats an operation and a halt based on the output values from each sensor and the prescribed temperatures, and hereby adjusts the temperature of each compartment.

On the other hand, when an accumulation of time for which the compressor 11 is caused to operate reaches a prescribed length of time, or when the numbers counted for each opening and closing of the respective doors 7, 8 and 9 reaches prescribed numbers, the controller 20 sends electric current to a defrost heater 25 which has been provided underneath the evaporator 16, and hereby start an operation of defrosting. In the course of a defrosting operation, the compressor 11 and the blowing fan 10 are caused to halt the operations thereof. In addition, an output value from a defrost sensor 23 (hereinafter referred to as a “D sensor”) which has been arranged in the vicinity of the accumulator 17 is transmitted to the controller 20. The controller 20 determines that frost covering the evaporator 16 has completely melt, when an output value from the defrost sensor 23 comes to be higher than a prescribed temperature, for example 3° C., which has been determined in advance. Hereby, the controller turns off electric current to the defrost heater 25, and accordingly completes the defrosting operation.

With regard to a detector 29, each of the refrigerator compartment 4, the vegetable storage compartment 5, the freezer compartment 6 and the machine compartment 13 is provided with a refrigerant leak sensor 26 for detecting a refrigerant leak when the concentration of a refrigerant gas reaches a prescribed value. The refrigerant leak sensor 26 outputs information regarding the refrigerant leak to the controller 20 when the concentration of the refrigerant gas reaches a prescribed value. A refrigerant leak in the low pressure area of the refrigeration cycle, for example in the connecting pipes or the like of the evaporator 16, would be detected by the refrigerant leak sensors 26 which have been provided to the refrigerator compartment 4, the vegetable storage compartment 5 and the freezer compartment 6. A refrigerant leak in the high pressure area of the refrigeration cycle, for example in the connecting pipes of the compressor 11, the condenser 14 and the like which has been arranged mainly in the machine compartment 13 would be detected by the refrigerant leak sensor 26 which has been arranged in the machine compartment 13.

The detector 29 does not have to use the refrigerant leak sensor 26, and may be configured instead to detect a refrigerant leak in advance. For example, by providing a temperature sensor to each of the outlet and inlet of the evaporator 16, a refrigerant leak may be detected in advance through the difference in the temperature of the evaporator 16. In addition to this, a refrigerant leak may be detected in advance through a fluctuation in the pressure, duties, voltage or the like of the compressor 11.

If a leak is to be caused in particular in the low pressure area of the refrigeration cycle, the refrigerant will not leak out, since the air is sucked into through the leak. In the evaporator 16, the refrigerant gas in the pipe is diluted, and therefore the difference in the temperature occurs between the outlet and the inlet. In addition, the compressor 11 is overloaded by the suction, and accordingly a fluctuation in the pressure or the duties occurs. In addition, if the compressor 11 halts, the refrigerant is going to leak out through the leak gradually. Taking this into consideration, a refrigerant leak can be detected in advance through detecting the fluctuation in the temperature of the evaporator 16, the pressure of the compressor 11 or the like.

An alarming device 27 gives an alarming signal to users through a buzzer, an announcement or a display from the control panel 22 and the like after a prescribed length of time (i.e. 90 minutes) has passed, when information regarding a refrigerant leak being detected by the detector 29 is transmitted to the controller 20. In this case, the condition of the refrigerator, measures to be taken for this, or the like may be informed through the announcement or the display, or may be informed to a household terminal device or to a cellular phone.

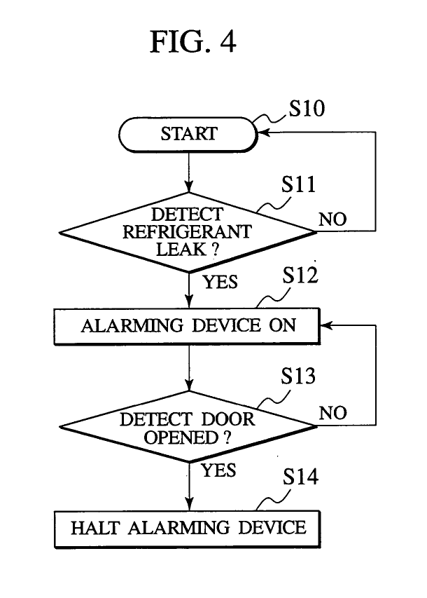

Next, a series of steps against a refrigerant leak of the refrigerator will be described hereinafter with reference to the flowchart of FIG. 4.

In a state that the detector 29 operates (S10), if the detector 29 defects that a refrigerant has leaked or detects in advance that a refrigerant is to leak (S11), the controller 20 causes the alarming device 27 to operate (S12) after a prescribed length of time has passed. At this time, a refrigerant leak is detected in the low pressure area of the refrigeration cycle (i.e. in the vicinity of the evaporator, the vegetable storage compartment and the freezer compartment), the controller 20 causes a shutoff valve 24, which has been provided to the outlet of the condenser 14, to close, and causes the compressor 11 to operate for a certain period of time (i.e. 90 seconds) so as to recover a refrigerant in the low pressure area of the refrigeration cycle. Furthermore, the controller 20 causes the blowing fan 10 to operate so as to circulate a refrigerant gas lest the refrigerant gas should suffuse the bottom of the compartment. On the contrary, if a refrigerant leak is detected in the high pressure area of the refrigeration cycle (i.e. in the machine compartment), the controller 20 causes a cooling fan, which has been provided to the machine compartment 13 for the purpose of cooling the compressor 11, to operate, and hereby diffuses the leaking refrigerant gas to the outside of the compartment.

The controller 20 detects that each of the doors 7, 8 and 9 is opened with a door switch or the like which has been provided to each door (S13). When the controller detects that one of the doors has been opened, the controller causes the alarming device 27 to halt (S14).

According to the embodiment, therefore, even if users operate the control panel by feeling uncomfortable with buzzing sounds or voices as the alarming signal, the alarming signal by the alarming device 27 is not turned off if the users do not open a door. Accordingly, users have to open a door even if the users feel annoyed. The opening of the door lets the refrigerant gas diffuse into the air without suffusing the compartments so that the concentration comes to lower than the concentration of inflammation. For this reason, even if a source of ignition is outside the compartments, the refrigerant gas will not be inflamed. This could improve a degree of the safety.

Conditions for halting the alarming device 27 are not limited to the opening of the door. Combination of the opening of the door with the operation of the control panel could be the conditions for halting the alarming device. In addition, the alarming device 27 preferably urges users to open a door with an announcement or a display.

If the alarming device 27 is caused to halt after the opening of all of the doors 7, 8 and 9 is detected, it also serves for the object of the present invention. Since an HC refrigerant has a higher specific gravity than the air, the refrigerant gas tends to suffuse the lowermost part of the storage compartments. However, compartments which the refrigerant gas would suffuse may change one after another depending on whether or not each of the refrigerator compartment and the freezer compartment is provided with such a cooling unit exclusive for each compartment that the flow of cold air can be controlled for each of the compartments, or depending on an amount or position of stored food. In such a case, if all the doors are caused to open although any particular storage compartment tends to be suffused, and if the alarming device 27 is caused to halt after it is detected that all the doors are caused to open, this could surely prevent the refrigerant gas from suffusing the compartments, and could promptly diffuse the refrigerant gas into the air. This could improve a degree of the safety.

Furthermore, when a refrigerant leak is detected by the detector 29, if the alarming device 27 is caused to halt after the opening of all the doors of the storage compartments into which cold air flows by causing the damper 12 to open, this also serves for the object of the present invention. In this embodiment, for example while the damper 12 is being caused to open, the refrigeration cycle is caused to communicate with the refrigerator compartment 4 and the vegetable storage compartment 5. For this reason, it is likely that the refrigerant gas also flows into the refrigerator compartment 4 and the vegetable storage compartment 5 if a refrigerant leak is to occur. By opening the doors 7 and 8, therefore, the refrigerant gas surely can be caused to diffuse.

While in a state that the damper 12 is caused to close, the refrigerant gas does not circulate to the refrigerator compartment 4 and the vegetable storage compartment 5. Accordingly, the doors 7 and 8 do not have to be caused to open. If the alarming device 27 is caused to halt after doors other than the doors of the storage compartment into which cold air does not flow are caused to open, users are allowed to do nothing but open doors which have to be opened. As a consequence, the refrigerant gas can be caused to diffuse promptly and securely. In this case, if the control panel or the like can show which doors should be opened, this serves for the object of the present invention more effectively.

### Second Embodiment of the Present Invention

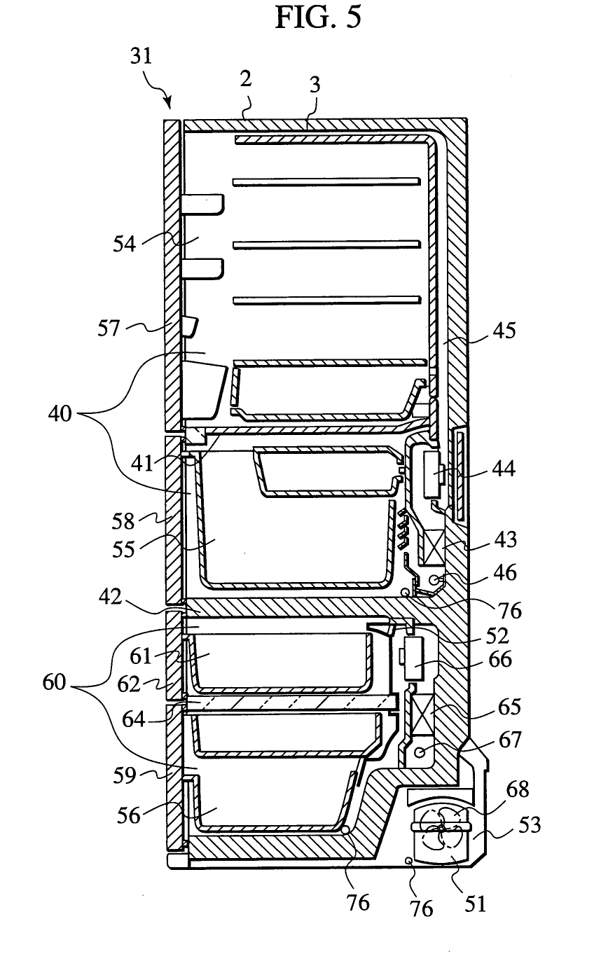

A refrigerator according to a second embodiment of the present invention will be described hereinafter with reference to drawings. As shown in the cross sectional view of FIG. 5, a main body 31 of the refrigerator is provided with a refrigerator space 40 and the freezer space 60. The refrigerator space 40 is provided therein with a refrigerator compartment 54 and a vegetable storage compartment 55 in order from the top. The freezer space 60 is provided therein with a multiple purpose compartment 61 and a freezer compartment 56 in order from the top. Incidentally, an icemaker compartment, which is not illustrated, is arranged next to the multiple purpose compartment 61 so as to be side by side with the multiple purpose compartment.

A door 57 with heat insulating properties that is opened and closed with hinges furnished is provided to the front of the refrigerator compartment 54. A door 58 with heat insulating properties that can be pulled open like a drawer is provided to the front of the vegetable storage compartment 55. A door 62 with heat insulating properties that can be pulled open like a drawer is provided to the front of the multiple purpose compartment 61. A door 59 with heat insulating properties that can be pulled open like a drawer is provided to the front of the freezer compartment 56. The refrigerator compartment 54 and the vegetable storage compartment 55 are sectioned off by a plastic partition plate 41. The vegetable compartment 55, the multiple purpose compartment 61 and the icemaker compartment are sectioned off by a partition wall 42 with heat insulating properties. The multiple purpose compartment 61 and the icemaker compartment are also sectioned off by a partition wall 64 with heat insulating properties.

A refrigerator evaporator 43, an R fan 44 which constitutes a refrigerator cold air circulation fan, an R defrost heater 46 for defrosting frost covering the refrigerator evaporator 43 and the like are arranged in the back of the vegetable storage compartment 55. While this R fan 44 is caused to operate, cold air which has been cooled by the refrigerator evaporator 43 is supplied to the inside of the refrigerator compartment 54 through the duct 45, and hereafter is circulated to the vegetable storage compartment 55. The refrigerator compartment 54 and the vegetable storage compartment 55 are configured to be cooled in this manner.

An F fan 66 which constitutes a freezer cold air circulation fan, a freezer evaporator 65, an F defrost heater 67 for defrosting frost covering the freezer evaporator 65 and the like are arranged in order from the top in the back of the freezer compartment 56. While the F fan is caused to operate, cold air which has been cooled by the freezer evaporator 65 is circulated to the icemaker compartment and the freezer compartment 56, and hereby cools the icemaker compartment and the freezer compartment 56. The R defrost heater 46 and the F defrost heater 67 are structured of a pipe heater and a conduit heater, and are controlled by sending electric current thereto with a temperature which is lower than the inflammation temperature of a inflammable refrigerant. These heaters may be heaters constructed of explosion-proof glass pipes and the like.

The multiple purpose compartment 61 is constructed so that the inner temperature can be switched to at a plurality of levels of temperature step by step through a control panel 92 or the like which has been arranged in the front of the door 62. Specifically, the damper 52 for automatically adjusting the degree of opening of the outlet of cold air in accordance with prescribed temperatures is arranged in the back of the multiple purpose compartment 61. Accordingly, the controlling of openings and closings of the damper 52 enables the multiple purpose compartment 61 to be used selectively as one of a refrigerator compartment (the compartment temperature is approximately 2° C.), a vegetable storage compartment (the compartment temperature is approximately 3° C.), a chilling compartment (the compartment temperature is approximately 0° C.), a partially freezing compartment (the compartment temperature is approximately −3° C.), a freezer compartment (the compartment temperature is approximately −18° C.) and a wine storage compartment (the compartment temperature is approximately 8° C.).

A machine compartment 53 is arranged in the bottom of the main body 31 of the refrigerator. In the inside of the machine compartment 53, the compressor 51, a condenser 74 constituted of wired condenser, a machine compartment fan 68 for heat radiation to cool the compressor 51, the condenser 74 and the like are arranged.

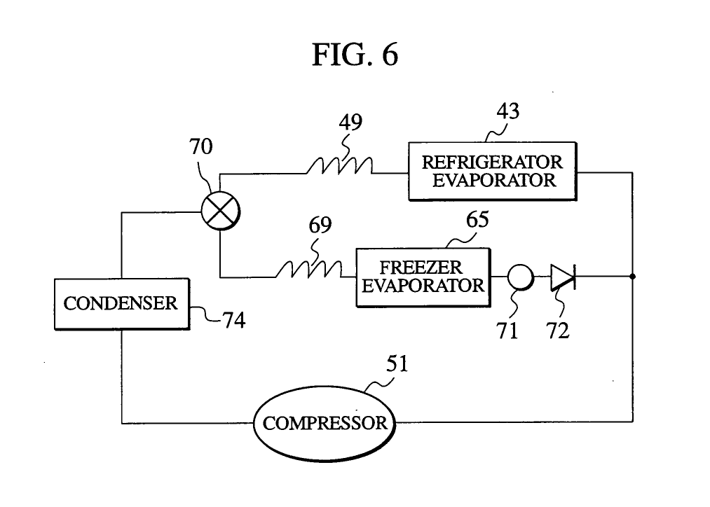

As shown in FIG. 6, in the refrigeration cycle of the refrigerator according to the embodiment of the present invention, the compressor 51, the condenser 74, and a switch valve 70 which functions as a switch are connected in series. Between this switch valve 70 and the compressor 51, a connecting pipe to which an R capillary tube 49 and the refrigerator evaporator 43 are connected as well as a connecting pipe to which an F capillary tube 69, the freezer evaporator 65, an accumulator 71 and an check valve 72 are connected are connected in parallel.

The switch valve 70 includes a function to switch back and forth between a first refrigerating operation and a second refrigerating operation by switching the two above described connecting pipes. The first refrigerating operation supplies a refrigerant to the connecting pipe to which the F capillary tube 69, the freezer evaporator 65, the accumulator 71 and the check valve 72. The second refrigerating operation supplies a refrigerant to the connecting pipe to which the R capillary tube 49 and the refrigerator evaporator 43. Inflammable refrigerants (e.g. an HC refrigerant) are used for the refrigerant.

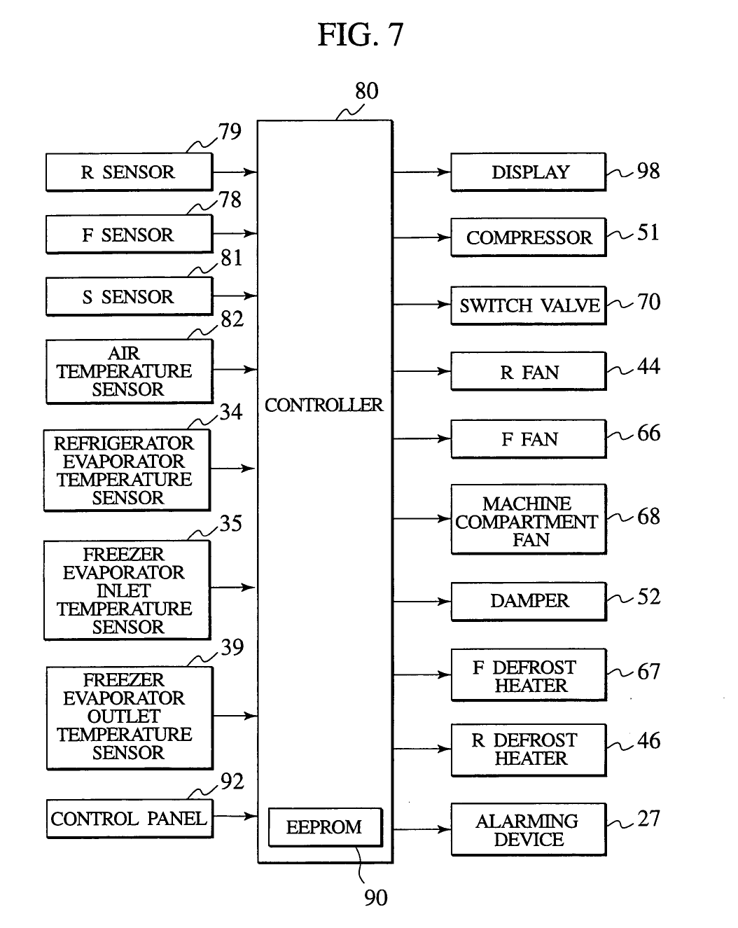

As shown in the diagram of the control block of FIG. 7, a controller 80 in the refrigerator according to the embodiment is configured to receive a signal regarding a detected temperature from each of an R sensor 79 for detecting the temperature in the refrigerator compartment 54, an F sensor 78 for detecting the temperature in the freezer compartment 56, an S sensor 81 for detecting the temperature in the multiple purpose compartment 61, an air temperature sensor 82 for detecting the temperature outside the compartments, a refrigerator evaporator temperature sensor 34 for detecting the temperature of the refrigerator evaporator 43, a freezer evaporator inlet temperature sensor 35 for detecting the temperature at the inlet of the freezer evaporator 65, and a freezer evaporator outlet temperature sensor 39 for detecting the temperature at the outlet of the freezer evaporator 65.

In addition, the controller 80 is configured to operate a display 98 which is arranged in a control panel 92, the compressor 51, the switch valve 70, the R fan 44, the F fan 66, the machine compartment fan 68, the damper 52, the defrost heater 67, the R defrost heater 46, the alarming device 27. The compressor 51, the R fan 44, the F fan 66, and the machine compartment fan 68 each are configured to be operated with variable speeds by an inverter circuit included in the controller 80.

In this refrigerator, when a refrigerating/cooling operation for cooling the refrigerator compartment 54 (i.e. the second refrigerating operation) is performed, the controller 80 switches the switch valve 70 to the connecting pipe for the second refrigerating operation, and concurrently causes the R fan 44 and the machine compartment fan 68 to operate. By this, a refrigerant that has been compressed into high temperature and pressure gas by the compressor 51 is sent to the condenser 74, and therein turns into liquid form while dissipating the heat. Hereafter, the refrigerant liquid is sent to the refrigerator evaporator 43 through the switch valve 70 and the R capillary tube 49. Then, the refrigerant liquid evaporates inside the refrigerator evaporator 43, and absorbs heat from the surroundings at that time. Thus, air around the refrigerator evaporator 43 is cooled. Cold air produced at this time is supplied to the refrigerator compartment 54 by a blowing operation by the R fan 44, and cools the refrigerator compartment 54. In addition, the R fan 44 is caused to operate in the course of a freezing/refrigerating operation (i.e. the first refrigerating operation), and facilitates the defrosting of frost covering the refrigerator evaporator 43. The defrosting causes the frost to vaporize or liquefy, and the cold air produced at this time is circulated inside the refrigerator compartment 54. Cold air produced at this time raises the humidity in the refrigerator compartment 54.

On the other hand, in the case that a freezing/refrigerating operation for cooling the freezer compartment 56 (i.e. the first refrigerating operation) is performed, the controller 80 switches the switch valve 70 to the connecting pipe for the first refrigerating operation, and concurrently causes the F fan 66 and the machine compartment fan 68 to operate. By this, a refrigerant that has been compressed into high temperature and pressure gas by the compressor 51 is sent to the condenser 74, and therein turns into liquid form while dissipating the heat. Hereafter, the refrigerant liquid is sent to the freezer evaporator 65 through the switch valve 70 and the F capillary tube 69. Then, the refrigerant liquid evaporates inside the freezer evaporator 65. Thus, air around the freezer evaporator 65 is cooled. At this time, cold air is supplied to the freezer compartment 56 by a blowing operation by the freezer fan, and cools the freezer compartment 56. Incidentally, the multiple purpose compartment 61 is configured so that an amount of supplied cold air is adjusted by the damper 52 in order to make the compartment temperature equal to a prescribed temperature.

In addition, in an operation of defrosting the freezer evaporator 65, when an accumulation of time for which the compressor 51 is caused to operate reaches a prescribed accumulated time of operation, the freezing/refrigerating operation is caused to halt. At this time, the controller 80 switches the switch valve 70, and hereby shuts off the flow of the refrigerant to the refrigerator evaporator 43 and the freezer evaporator 65. Subsequently, the controller 80 causes the compressor 51 to operate for a prescribed length of time, and hereby recovers the refrigerant from the low pressure area including the evaporators. In addition, the controller 80 sends electric current to the F defrost heater 67, and hereby starts to defrost the freezer evaporator 65. When the temperature detected by the freezer evaporator outlet temperature sensor 39 reaches a prescribed temperature, the controller 80 turns off electric current to the F defrost heater 67, and completes the defrosting operation by switching the switch valve 70 so that the refrigerant flows to the refrigerator evaporator 65. Incidentally, an operation of defrosting the refrigerator evaporator 43 is performed by sending electric current to the R defrost heater 46, as in the case of the operation of defrosting the freezer evaporator 65.

Control to be exercised when a refrigerant in the refrigeration cycle leaks out will be described hereafter. When the detector 29 for detecting a refrigerant leak detects a refrigerant leak in the high or low pressure areas of the refrigeration cycle, the following control is exercised.

When a refrigerant leak is detected in the high pressure area of the refrigeration cycle, the controller 80 causes the machine compartment fan 68 to operate for a prescribed length of time (e.g. 90 minutes), and hereafter causes the alarming device 27 to give users an alarming signal for warning against a refrigerant leak with a buzzer, an announcement, a display or the like.

In this regard, the high pressure area of the refrigeration cycle is defined as the area from the outlet of the compressor 51 to the inlets of the R capillary tube 49 and the F capillary tube 69 in the refrigeration cycle. Almost all the constituent members of the high pressure area are arranged in the machine compartment 53.

The followings were observed in an experiment. When a refrigerant leak was caused in the high pressure area so as to let the refrigerant gas suffuse the machine compartment 53, the refrigerant gas diffused from the machine compartment 53 into the air for approximately 45 minutes through the natural circulatory motion of the air. Hereby, the concentration came to be lower than the inflammation concentration of the inflammable refrigerant. This proves that, if a refrigerant leak is to occur in the high pressure area, prompt diffusion of the refrigerant is effective. Against this background, in the embodiment of the present invention, a refrigerant gas is diffused by causing the machine compartment fan 68 to operate for a prescribed length of time, and hereby a degree of the safety could be improved.

If, however, a refrigerant leak is informed of with an announcement or a display immediately after the refrigerant leak is detected, it is likely that users feel so upset that the users pull out the plug so that the diffusion by operating the fan is hindered. For this reason, the controller 80 causes the alarming device 27 to operate when a prescribed length of time (e.g. 45 minutes) has passed after the occurrence of a refrigerant leak. In this regard, if the machine compartment fan 68 is out of order, it takes longer to let the leaked refrigerant gas diffuse out. For this reason, it is preferable that a detector for detecting a disorder such as a trouble with the machine compartment fan 68 is provided thereto, and that a prescribed length of time from an occurrence of a refrigerant leak to the giving of an alarming signal is set longer (e.g. one hour) if a trouble with the machine compartment fan 68 is detected.

If a refrigerant leak is detected in the low pressure area of the refrigeration cycle, the flow of the refrigerant to the refrigerator evaporator 43 and the freezer evaporator 65 is shut off by operating the switch valve 70, and the refrigerant in the low pressure area including the evaporators is recovered by causing the compressor 51 to operate for a prescribed length of time. Concurrently, the diffusion in the compartments is performed by causing the R fan 44 and the F fan 66 to operate uninterruptedly. Hereby, after the refrigerant has been recovered, users are informed of this.

Herein, the low pressure area of the refrigeration cycle is defined as the area from the inlets of the R capillary tube 49 and the F capillary tube 69 to the outlets of the refrigerator evaporator 43 and the check valve 72. The two connecting pipes in the low pressure area are connected to the respective cooling areas through the duct 45 and the like. If a refrigerant leak is to occur in this low pressure area, the refrigerant gas gradually suffuses the compartments since the spaces inside the compartments are sealed off by the doors, even though an amount of the leaking refrigerant is small because the refrigerant gas is low pressurized.

In an experiment where a refrigerant leak was caused in a pipe in the vicinity of an evaporator, it was observed that it took several hours for the concentration of the refrigerant to come to be equal to, or higher than, the concentration of inflammation. With this taken into consideration, when a refrigerant leak is to occur in the low pressure area of the refrigerant cycle, the prompt recovering of the refrigerant in the low pressure area is effective, since the diffusion by the natural circulatory motion of the air is not in the area. Against this background, the controller 80 switches the switch valve 70, and hereby shuts off the flow of the refrigerant to the refrigerator evaporator 43 and the freezer evaporator 65. Subsequently, the controller 80 causes the compressor 51 to operate for a prescribed length of time. Hereby, the refrigerant in the low pressure area is recovered.

In addition, an inflammable refrigerant accumulates around the bottoms of the compartments, since the inflammable refrigerant is heavier than the air. Accordingly, the concentration becomes higher around the bottoms of the compartments. To prevent this, the controller 80 causes the R fan 44 and the F fan 66 to operate so as to circulate the air in the compartments, and hereby causes the refrigerant to diffuse in the compartments.

It is likely that, if an alarming signal is given immediately after a refrigerant leak occurs in the low pressure area of the refrigeration cycle, users feel so upset that the users turn off the power supply, and that accordingly the refrigerant cannot be recovered fully. For this reason, the controller 80 causes the alarming device 27 to give an alarming signal after the recovering of the refrigerant is completed.

The detector 29 will be described below. The detector 29 detects a refrigerant leak by finding the difference in the temperature between the inlet and the outlet of the freezer evaporator 65, i.e. the difference between a temperature found by the freezer evaporator inlet temperature sensor 35 and a temperature found by the freezer evaporator outlet temperature sensor 39. Otherwise, the detector 29 detects a refrigerant leak by finding a fluctuation in duties of the compressor 51.

In the high pressure area of the refrigeration cycle, if a crack or a leak is to be caused in a joint of pipes or the like, the refrigerant leaks out of the pipe because the refrigerant is high pressurized. As a consequence, the load cast on the compressor 51 decreases, and accordingly a tendency towards decreased duties is noticed. In the high pressure area, therefore, a refrigeration leak is detected by finding the decrease in the duties of the compressor 51.

On the other hand, in the low pressure area of the refrigeration cycle, if a crack or a leak is to be caused in a joint of pipes or the like, the air is sucked into the pipes, since the refrigerant is low pressurized in the course of a refrigerating operation. For this reason, the performance of refrigeration by the evaporator becomes lower, and accordingly the difference in the temperature between the inlet and the outlet of the evaporator appears. In addition, the compressor 51 comes to be overloaded, since the compressor 51 has sucked up the air. Accordingly a tendency towards increased duties is noticed. With this taken into consideration, in the low pressure area, a refrigerant leak is intended to be detected in advance through finding the difference in the temperature between the inlet and the outlet of the evaporator before the refrigerant leak occurs, or through finding the increase in the duties.

It should be noted that, if the detector 29 detects a refrigerant leak through finding an abnormal pressure in the refrigeration cycle or an abnormal condition of the voltage applied onto the compressor 51, this also serves the object of the present invention. In addition, if a refrigerant leak sensor is provided to each of the storage compartments, the machine compartment and the like, this also serves the object of the present invention.

(A Set 1 of Steps to be Taken for Halting an Alarming Device)

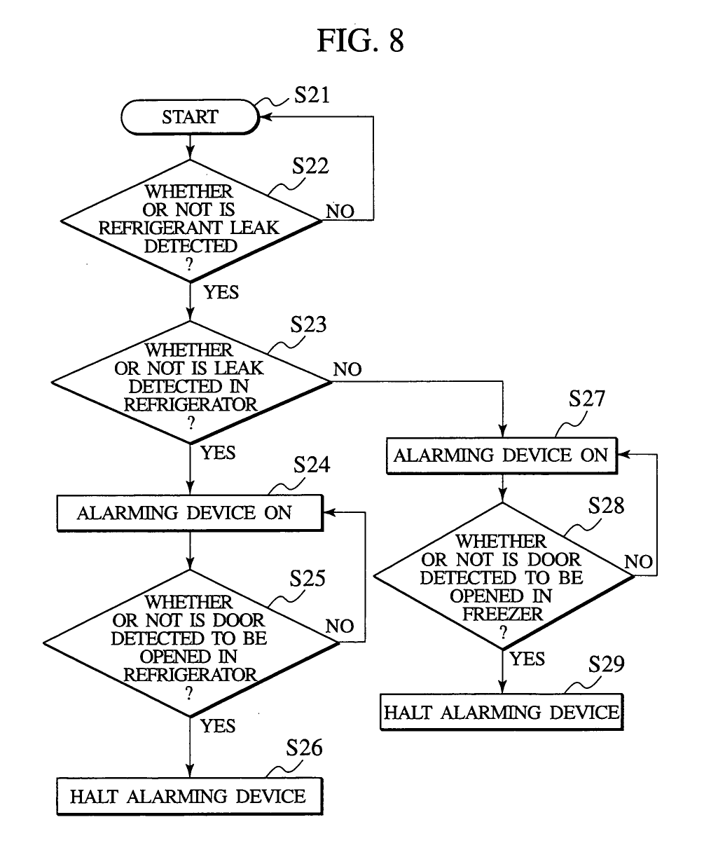

Next, an explanation will be given of steps to be taken if a refrigerant leak is to occur in the low pressure area of the refrigeration cycle. As shown in FIG. 8, first of all, the detector 29 is caused to operate (S21). If the detector 29 detects that a refrigerant has leaked (S22), or detects in advance that a refrigerant is to leak (S22), the controller 80 determines whether the refrigerant leak has occurred/is to occur in a refrigerating/cooling space 40 or in a freezing space 60 (S23). In this case, it is preferable that the refrigerant leak is detected by a refrigerant leak sensor 76, which has been provided, as shown in FIG. 5, to each of the lower backs of the vegetable storage compartment 55 in the refrigerating/cooling space 40 and the freezer compartment 56 of the freezing space 60. If refrigerant leak sensor 76 is provided instead to other storage compartments and the machine compartment, this also serves the object of the present invention.

If the step S23 determines that a refrigerant leak occurs in the refrigerating/cooling space 40, the controller 80 recovers the refrigerant, and concurrently causes the R fan. 44 and the F fan 66 to operate so that the refrigerant is caused to diffuse. Hereafter the controller 80 causes the alarming device 27 to give an alarming signal to users after a prescribed length of time has passed (S24). Then, the controller 80 causes the alarming device 27 to halt after one of the doors 57 and 58 of the refrigerating/cooling space 40 is opened by users (S25 and S26). At this time, if the alarming device 27 is caused to halt after both the door 57 and the door 58 are opened instead, this also serves for the object of the present invention.

On the other hand, if the step S23 determines that a refrigerant leak occurs in the refrigerating space 60, the controller 80 recovers the refrigerant, and concurrently causes the R fan 44 and the F fan 66 to operate so that the refrigerant is caused to diffuse. Hereafter, the controller 80 causes the alarming device 27 to give an alarming signal to users after a prescribed length of time has passed (S27). Then, the controller 80 causes the alarming device 27 to halt after one of the door 62 and the door 59 of the freezing space 60 is opened by users (S28 and S29). At this time, if the alarming device 27 is caused to halt after both the doors 62 and 59 are opened instead, this also serves for the object of the present invention.

Consequently, this configuration makes it unnecessary to open the doors of a compartment other than a space which cold air is not sent into, and which accordingly the refrigerant gas does not suffuse, even if a refrigerant leak is to occur in one of the refrigerating/cooling space 40 and the freezing space 60. For this reason, users are allowed to do nothing but open doors which have to be opened. As a consequence, the refrigerant gas can be caused to diffuse promptly and securely. In this case, the diffusion of the refrigerant gas can be performed more effectively, if the alarming device 27 is caused to tell which door should be opened with an announcement or a display or with an alarming signal whose sounds are made different.

(Another Set 2 of Steps to be Taken for Halting an Alarming Device)

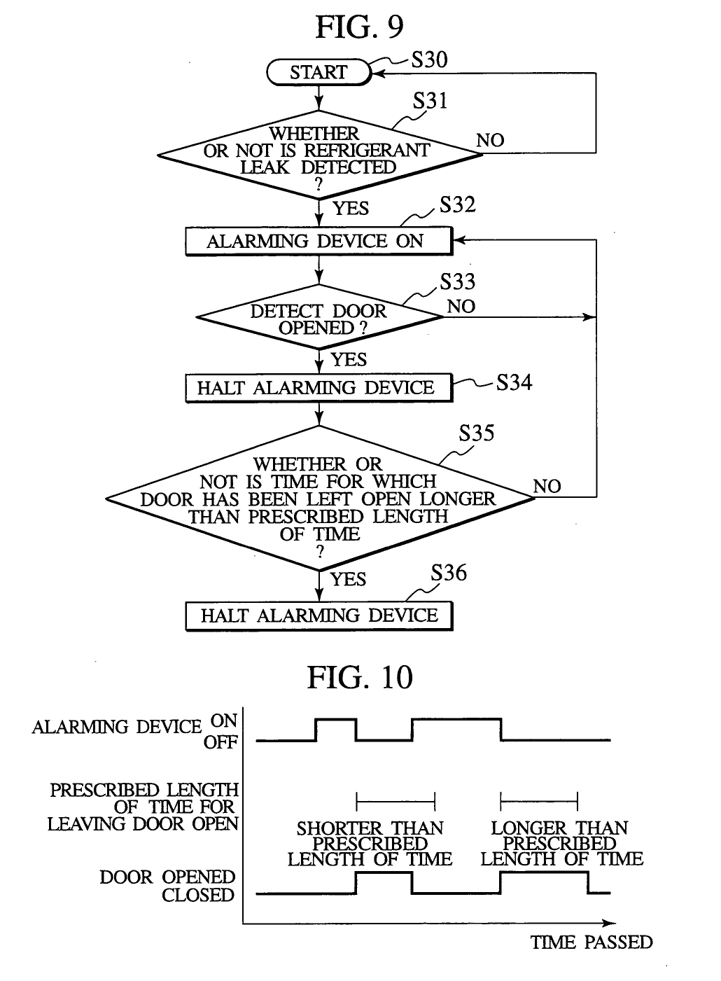

Next, another set of steps to be taken for halting an alarming device 27 will be described. As shown in the flowchart of FIG. 9, when a refrigerant leak is detected by the detector 29 (S30) and hereby the detector 29 finds the refrigerant leak (S31), the controller 80 causes the alarming device 27 to give an alarming signal after a prescribed length of time has passed (S32).

When an opening of a door is detected (S33), the alarming device 27 is caused to halt (S34). Users, however, may feel at ease when the alarming device 27 is causes to halt, and accordingly may close the door immediately. As a result, the diffusion into the air may be hindered. For this reason, the controller 80 is designed to determine whether or not the door is left open uninterruptedly longer than a prescribed length of time (e.g. one hour)(S35). If the door has not yet been left open longer than the prescribed length of time, the controller 80 causes the alarming device 27 to give a continuous alarming signal. If the door has been left open longer than the prescribed length of time, the controller 80 determines that the diffusion into the air has completed, and hereafter causes the alarming device 27 to halt (S36).

As shown in the timed chart of FIG. 10, after the alarming device 27 is caused to operate, the alarming device 27 is once caused to halt if a door is opened. The alarming device 27 is, however, going to be caused to operate again, if a door is closed although the door has been left open shorter than a prescribed length of time. In this way, the alarming device 27 is designed not to be caused to halt if a state of the door being left open is not maintained longer than a prescribed length of time.

In other words, even if users open a door by being urged to do so by an alarming signal such as a buzzer, a voiced instruction, a display or the like through the control panel or the like after a refrigerant leak occurs, the refrigerant gas eventually suffuses the compartments if the users close the door although the refrigerant gas has not diffused fully into the air since the door has been left open for a shot length of time, and if hereafter the users turn off the alarming device 27. The above described configuration, however, can have users surely leave a door open longer than a prescribed length of time.

Since this configuration surely gets a door to be left open surely for a prescribed length of time, the refrigerant gas does not suffuse the compartments, and instead diffuses into the air. Accordingly, the concentration of the diffused refrigerant gas comes to be lower than the concentration of inflammation. Even if a source of ignition is outside the compartments, there is no risk of inflammation, and a degree of safety is high. This configuration makes it possible to provide such a refrigerator.

Instead of causing a door to be left open longer than a prescribed length of time above mentioned, if time for which the door is left open is counted into an accumulated amount of time, this also serves for the object of the present invention.

(Yet Another Set 3 of Steps to be Taken for Halting an Alarming Device)

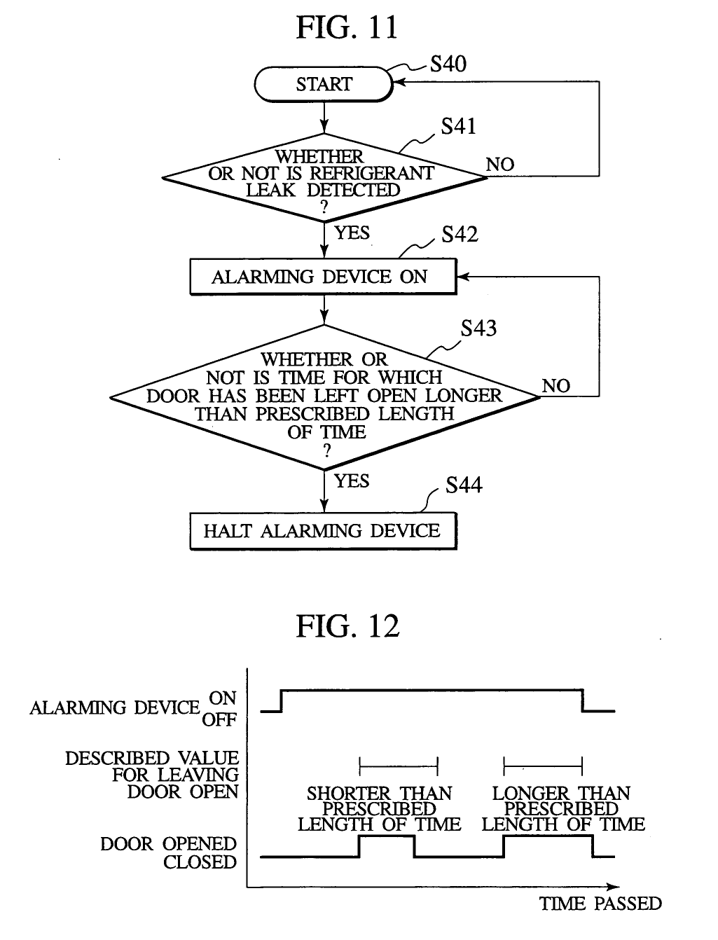

Furthermore, yet another set of steps to be taken for halting an alarming device 27 will be described. As shown in the flowchart of FIG. 11, when a refrigerant leak is detected by the detector 29 (S40) and hereby the detector 29 finds the refrigerant leak (S41), the controller 80 causes the alarming device 27 to give an alarming signal after a prescribed length of time has passed (S42).

The controller 80 determines whether or not a door has been left open longer than a prescribed length of time (e.g. more than one hour)(S43). If the door has been left open shorter than the prescribed length of time, it is likely that the refrigerant gas has not yet diffused fully out of the compartments. Accordingly, the alarming device 27 is caused to operate uninterruptedly (S42). If the prescribed length of time or more has passed, the controller 80 determines that the refrigerant gas has so diffused out of the compartments that the concentration of the refrigerant gas in the compartments comes to be lower than the concentration of inflammation, and hereby the controller 80 causes the alarming device 27 to halt (S44).

As shown in the timed chart of FIG. 12, when the time for which a door is left open comes to be longer than a prescribed length of time after the alarming device 27 is caused to operate, the alarming device 27 is caused to halt.

Since this configuration let users know that a dangerous condition exists even though the door is left open, the refrigerant gas that suffuses the compartments can be more securely diffused out of the compartment in safety.

(A Set 1 of Steps to be Taken When the Power Supply is Turned Off)

If the power supply is turned off in the course of an operation of the alarming device 27, the alarming device 27 is caused to operate uninterruptedly with an auxiliary power supply (e.g. a battery or the like) which has been provided onto a board or the like.

When users are given an alarming signal by the alarming device 27 all of a sudden, it is likely that the users feel so upset as to turn off the power supply by pulling out the plug in order to turn off the alarming device 27 even if the users are informed of how to cope with a refrigerant leak through an announcement or a display. In this case, the diffusion of the refrigerant gas by a fan, the recovering of the refrigerant by the compressor 11, and the urging of users to open a door are hindered.

In this configuration, even if the power supply is turned off, the alarming device 27 is caused to operate uninterruptedly by using the auxiliary power supply. Accordingly, this configuration can have users open a door, and hereby causes the refrigerant gas to securely diffuse out of the compartments. With regard to a method for giving an alarming signal when the power supply is turned off, users may be urged to turn on the power supply again, or tones of a buzzer or the like may be changed.

(Another Set 2 of Steps to be Taken When the Power Supply is Turned Off)

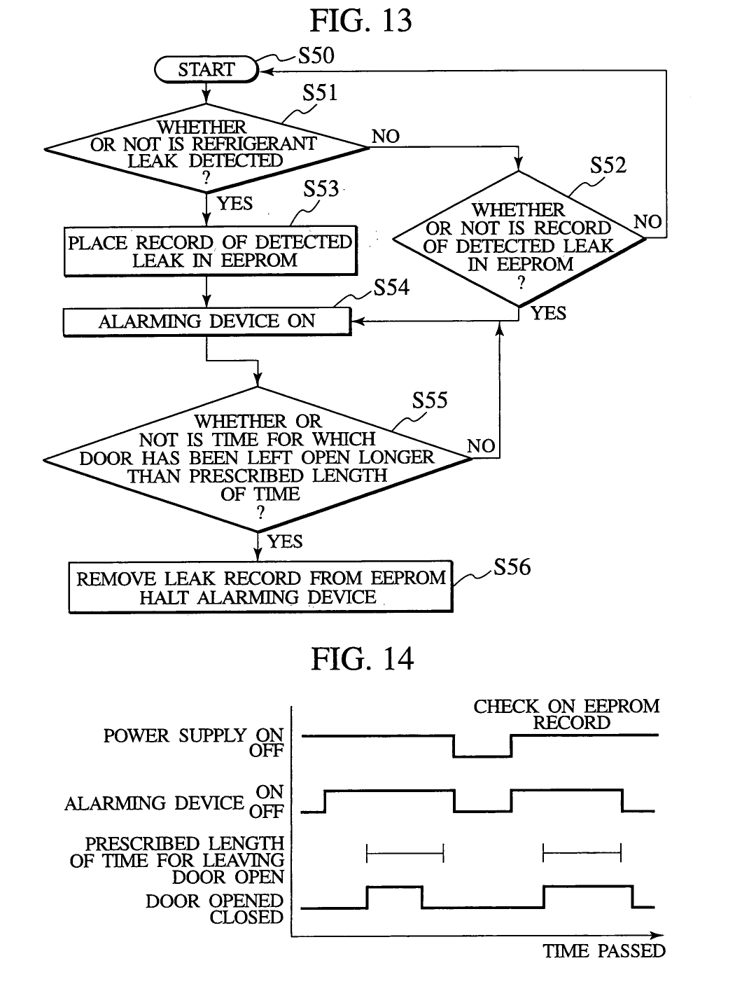

An explanation will be given of another set of steps to be taken when the power supply is turned off in the course of an operation of the alarming device 27. As shown in the flowchart of FIG. 13, if a refrigerant leak is detected by the detector 29 (S50) and hereby the detector 29 finds the refrigerant leak (S51), the controller 80 causes a built-in memory device, termed as an EEPROM 90, to memorize records regarding a refrigerant leak such as a fact that a refrigerant leak has occurred, a place where the refrigerant leak has occurred, and information on whether or not the refrigerant leak has been coped with (S53). Hereafter, the controller 80 causes the alarming device 27 to give an alarming signal after a prescribed length of time has passed (S54), and determines whether or not a time for which a door is left open has come to be longer than a prescribed length of time (S55). If the door has been left open longer than the prescribed length of time, the controller 80 causes the alarming device 27 to stop giving an alarming signal (S56). Incidentally, in the course of processing in the step S54, a record showing the alarming device 27 has given an alarming signal may be memorized in the EEPROM90. In the course of processing in the step S56, records of a refrigerant leak and an alarming signal to be given that have been memorized in the EEPROM90 are deleted.

As shown in the timed chart of FIG. 14, in the course of an operation of the alarming device 27 after a refrigerant leak is detected, if the power supply is once turned off and then is turned on, the detector 29 and the alarming device 27 are caused to halt. For this reason, even if a search of a refrigerant leak is started at the same time that the power supply is turned on again in the step S50 of FIG. 13, it is likely that a refrigerant leak cannot be detected although steps for diffusing the refrigerant gas has not yet been completed.

In this case, since a record of a refrigerant leak has already been memorized in the EEPROM90 in the step S53 of FIG. 13, the controller 80 consults the information (S52). If a record of a refrigerant leak is found, the controller 80 causes the alarming device 27 to give an alarming signal when a prescribed length of time has passed after the power supply is turned on (S54). If a record regarding a refrigerant leak is not found, the controller 80 continues searching for a refrigerant leak by the detector 29.

In addition, if a record of an alarming signal given is memorized in the EEPROM, the controller 80 causes the alarming device 27 to give an alarming signal immediately after the power supply is turned on.

As a consequence, this configuration resumes giving an alarming signal when the power supply is turned on again, even if users feel so upset with an alarming signal warning against a refrigerant leak as to turn off the power supply. Accordingly, this configuration can surely diffuse the refrigerant gas out of the compartments by having users open a door. In this way, a degree of the safety could be improved.

It should be noted that, if a record of a refrigerant leak is found in the EEPROM90, not only the alarming device 27 may be caused to operate, but also, for example, processing for diffusing such as diffusing by the fans and recovering the refrigerant may be performed continuously.

Each of the above described embodiments of the present invention is only an example. Timings for operating the alarming device, conditions concerning a method for halting the alarming device, the alarming device and the like can be modified as long as the modifications do not depart from the spirit and the scope of the present invention. In addition, it goes without saying that the refrigerant leak detector, a method for diffusing a refrigerant, and the setting up of the prescribed length of time should be most suitable for the configuration of the refrigerator.

### Third Embodiment of the Present Invention

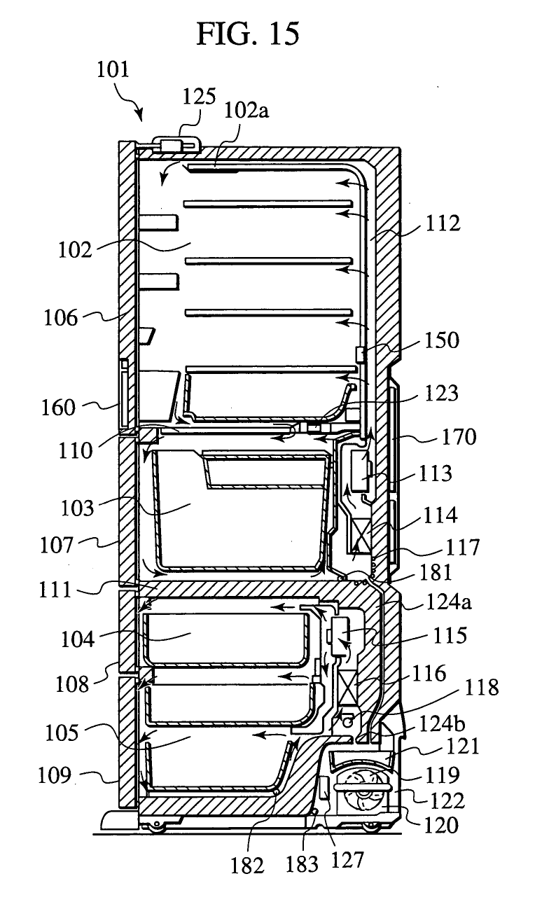

Next, a refrigerator according to a third embodiment of the present invention will be described with reference to drawings. As shown in FIG. 15, a main body 101 of the refrigerator is provided therein with a refrigerator compartment 102, a vegetable storage compartment 103, an icemaker compartment 104 and a freezer compartment 105 in order from the top. Incidentally, a multiple purpose compartment whose temperature can be switched to several ranges of temperature is so provided next to the icemaker compartment 104 as to be side by side with the icemaker compartment 104.

A door 106 with heat insulating properties that is opened and closed with hinges furnished is provided to the front of the refrigerator compartment 102. Doors 107, 108 and 109 with heat insulating properties that can be pulled open like a drawer are provided to the respective fronts of the vegetable storage compartment 103 the icemaker compartment 104 and the freezer compartment 105. The refrigerator compartment 102 and the vegetable storage compartment 103 are sectioned off by a plastic partition plate 110. The vegetable compartment 103, the icemaker compartment 104 and the multiple purpose compartment are sectioned off by a partition wall 111 with heat insulating properties for the purpose of making a flow of cold air in each of the compartments independent of one another. The icemaker compartment 104 and the multiple purpose compartment are also sectioned off by a partition wall with heat insulating properties.

The bottom of the refrigerator compartment 102 is provided with a deodorizer 123 for deodorizing the air in the compartment by activating a photocatalyst with high voltage. The top of the refrigerator compartment 102 is provided with a compartment light 102a which is switched on, when the door 106 is opened, by a door switch 157 for detecting an opening and a closing of the door 106.

In the front surface of the door 106 is provided with a control panel 160 which includes: a control unit 163 for exercising control such as adjusting the temperatures of the compartments, instructing refrigerating operations, switching displayed items, and doing other things; a display 161 for displaying operating conditions and temperatures; and an audio manipulator 162 for doing things such as giving an alarming signal and an announcement

In addition to being opened in a usual manner, the door 106 can be opened and closed in a mechanically assisted manner. The top of the main body 101 of the refrigerator is provided with a door opening unit 125 for opening the door 106 by pushing the door 106 with a solenoid and the like. Accordingly, touching on a handle or the like which has been installed in the control unit 163 or the door 106 causes the door opening unit 125 to operate so that the door is caused to open.

The rear of the vegetable storage compartment 103 is provided with: an R evaporator 114 which constitutes a refrigerating unit for the refrigerator compartment 102 and the vegetable storage compartment 103; an R fan 113 which constitutes a cold air circulation fan for the refrigerator, and an R defrost heater 117 for defrosting frost covering the R evaporator 114 and the like. These are configured as follows: when this R fan 113 is caused to operate, cold air which has been cooled by the R evaporator 114 is supplied into the refrigerator compartment 102 through a duct 112, and hereafter is flown through the vegetable storage compartment 103, and is circulated. Hereby, the cold air cools the refrigerator compartment 102 and the vegetable storage 103.

The rear of the freezer compartment 105 is provided, in order from the top, with: an F fan 115 which constitutes a cold air circulation fan for the freezer; an F evaporator 116 which constitutes a refrigerating unit for an icemaker compartment 104, the multiple purpose compartment and the freezer compartment 105; an F defrost heater 118 for defrosting frost covering the F evaporator 116; and the like. These are configured as follows: when the F fan 115 is caused to operate, cold air which has been cooled by the F evaporator 116 is supplied into the icemaker compartment 104 and the freezer compartment 105, and is circulated. Hereby, the cold air cools the icemaker compartment 104 and the freezer compartment 105. In addition, the R defrost heater 117 and the F defrost heater 118 are constructed of a pipe heater and a conduit heater, and are caused to operate with a temperature which is lower than the inflammation temperature of the inflammable refrigerant. Incidentally, the R defrost heater 117 and the F defrost heater 118 may be heaters which are constructed of explosion-proof glass pipes.

Underneath the R evaporator 114 and the F evaporator 116, drain pipes 124a and 124b are provided for draining water, into which frost is defrosted, to a water pan 121 which has been arranged in the machine compartment 122.

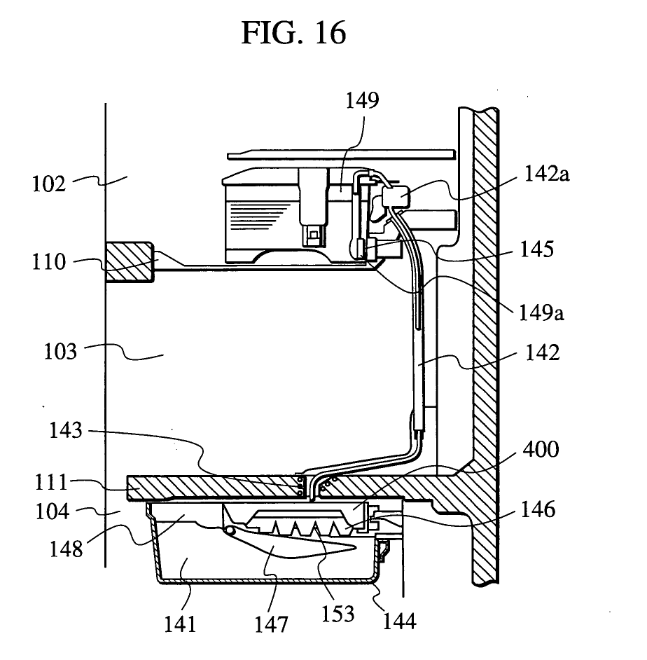

As shown in FIG. 16, the icemaker compartment 104 is provided with an ice cubes collection bin 144 and an automatic icemaker 141.

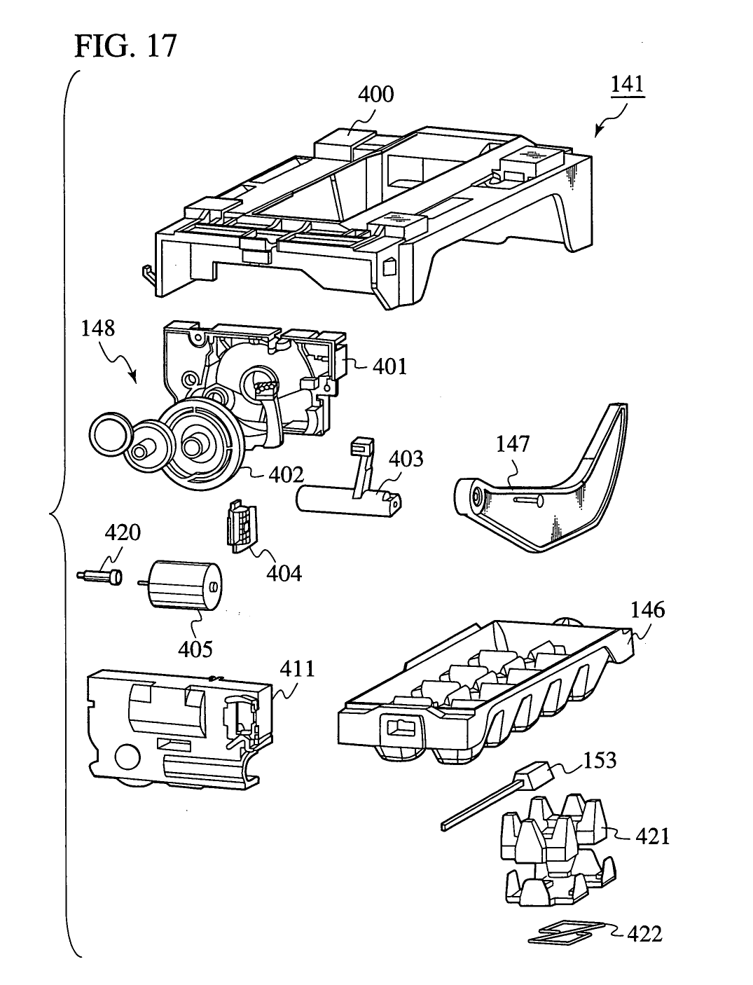

As shown in FIG. 16 and FIG. 17, the automatic icemaker 141 is installed onto the top of the icemaker compartment 104 with a cover 400 furnished. An ice mold 146 is supported by the cover 400 and an icemaker operator 148.

An operation by the icemaker operator 148 causes the detection lever 147 to move up and down through a detection stem 403 which communicates outwards. The icemaker operator 148 checks on the timings for supplying water and releasing ice cubes by using a signal detected by an I sensor 153 which is pressed into contact with an ice mold 146 by a spring 422 and an insulating member 421.

At a time when water supply is started, the icemaker operator 148 causes a water pump 145, which is provided to the refrigerator compartment 102, to operate and supply water to an ice mold 146 from a water tank 149 through a water pipe 142. At a time when the releasing of ice cubes is started, the icemaker operator 148 causes the ice mold 146 to turn upside down and release ice cubes down, and collects the ice cubes in the ice cubes collection bin 144.

The inner constitution of the icemaker operator 148 will be described here. A motor 405, a control board 404 and a detection stem 403 are arranged inside a case 401 and a case 411. A worm gear 420 is installed onto a shaft 408 of the motor 405. The worm gear 420 and the gear 402 engage with each other corresponding to the revolution of the motor 405. By this, the detection lever 147 is caused to move up and down, and the ice mold is caused to turn upside down.

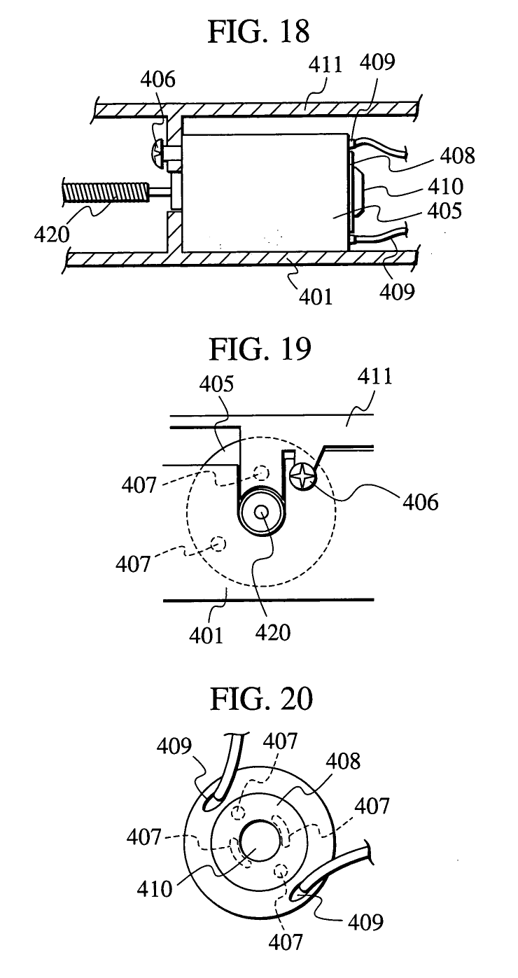

The motor 405 is installed into, and fixed to, the case 401 and the case 411. As shown in FIG. 18 and FIG. 19, on the side of the worm gear 420, a screw 406, the case 401 and the case 411 are designed to close a hole 407 of the motor 405. In addition to closing the hole 407, this screw 406 can prevent the motor 405 from rotating by being fitted into the case 401 and the case 411.

Furthermore, as shown in FIG. 20, on the side of a terminal 409 for supplying the power, a seal 410 for closing the hole 407 is adhered to the hole 407.

In general, the hole 407 needs to be provided for the purpose of assembling and adjusting the motor. When a brush motor is used, it is likely that a refrigerant gas flows into the motor 405 through this hole 407. If sparks are generated at a contact point, it is dangerous.

As discussed above, however, the screw 406, the case 401, the case 411 and the seal 410 altogether blocks the air from flowing into the motor 405, and the safety is ensured. Furthermore, even if the fabrication does not produce a fully sealed construction for this, the safety is ensured. The reason for this is as follows: when each of flexure of the seal and the clearance between the cases is small (less than 1 mm), flame does not come out even if the inside of the motor 405 is to set on fire. Rather, if the entire unit including the automatic icemaker and the like are intended to be constructed explosion-proofed, materials that can withstand the pressure of an explosion, if it is to occur, needs to be selected for the construction. The reason for this is as follows: if the inside of the motor 405 is to set on fire, the range of inflammability is large because of a large amount of gas to be burned. The above-described constitution could, however, minimize the range of inflammability. Even if a refrigerant gas is to flow into the motor 405, a range of inflammability is so small that a degree of safety is high.

In addition, when a brushless motor is used, if a ring varistor is provided to the rectifying rotor inside the motor, the ring varistor absorbs counter elective force which is generated by the coil when a phase of turning on electricity is switched, and hereby sparks are prevented from being generated at a contact point. Accordingly, a degree of the safety could be improved further.

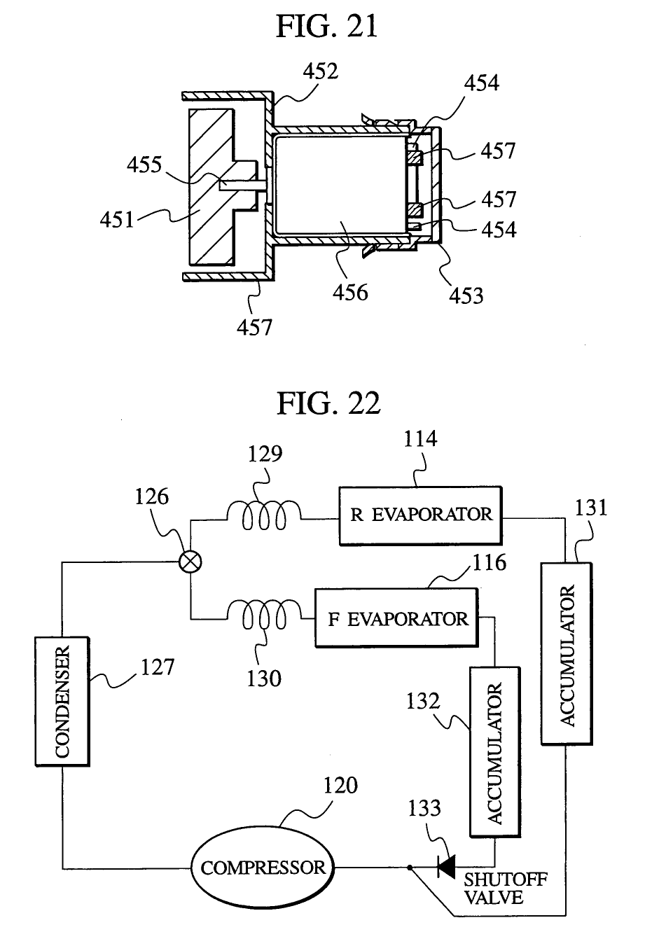

The motor used for the automatic icemaker 141 has been described. Similarly, a motor used in a water pump 145 may be constructed explosion-proofed of a case and a seal. The water pump 145 pours forth water by rotating an impeller 149a with a built-in magnet which has been arranged in the water tank shown 149 in FIG. 16 With regard to the water pump 145, as shown in FIG. 21, a motor 456 drives a shaft 455 whose extremity is provided with a magnet 451 for rotating the impeller, and hereby water is supplied to the icemaker. The case 452 and a case 453 cover the motor 456. When the case 452, the case 453 are fastened to each other with screws or the like on the side of the shaft 455, the cases 452 and 453 and the motor 456 are so pressed in contact with one another that holes are closed. It is preferable that the case 452, the case 453 and the motor are adhered to one anther with seals 457. Even if the fabrication leaves a small clearance between the cases, the safety is ensured. The reasons for this are as follows: if an ignition is to occur inside, the ignition cannot spread outwards. In addition, a combustion gas is so cooled by the cases that the combustion gas can no longer inflame a refrigerant gas outside. As a consequence, the safety is ensured.

On the other hand, if the holes are similarly closed with the seals 457 on the side of terminals 454, a refrigerant gas is prevented from flowing into the motor 456. Even if a refrigerant gas is to flow into the motor because of the exposure for a long time, an ignition inside does not spread out of the motor. In addition, oxygen comes to deplete inside the motor so that an inflammation, which would otherwise be caused, goes out. Accordingly, the safety is ensured.

To sum up, the above-described constitution would prevent a refrigerant gas from flowing into the motor, even if a brushless motor is used. Accordingly, the concentration of the refrigerant gas does not easily come to be higher than the concentration of ignition. Even if the concentration of the refrigerant gas is to come to be higher than the concentration of ignition so that the refrigerant gas is inflamed, the flame does not spread outwards because oxygen comes to deplete inside the motor. As a result, the above-described constitution would put users out of danger.

As shown in FIG. 16, the upper portion of the water pipe 142 is provided with a water intake 142a for receiving water that flows from the water tank 149. The water pipe 149 stretches downwards through the bottom of the vegetable storage compartment 103 and the insulating partition wall 111 into the freezer compartment 104. A water intake heater 143 for preventing the water pipe 142 from freezing is arranged in the inside of the insulating partition wall 111.

If a refrigerant leak is to occur in the refrigerant compartment 102 or the vegetable storage compartment 103, part of the leaking refrigerant may leak into the icemaker compartment 104 from the water intake 142a through the water pipe 142.

As shown in FIG. 15, the machine compartment 122 is arranged in the bottom of the main body 101 of the refrigerator. In this machine compartment 122 are arranged: a compressor 120; a condenser 127 which is constructed of a wire condenser; a C fan 119 which constitutes a heat radiating fan for cooling the compressor 120 and the condenser 127; the water pan 121 for reserving and evaporating water into which frost is defrosted, and which flows down through the drain pipes 124a and 124b; and the like.

The machine compartment 122 is provided with an air intake through which the air is sucked from the front, and a outlet through which the air that has been blown by an operation of the C fan 119 is exhausted from the rear of the machine compartment 122 after the air cools the condenser 127, the compressor 120 and the like.

As shown in FIG. 22, in the refrigeration cycle, the compressor 120, the condenser 127 and the switch valve 126 for switching between flows of the refrigerant and between a full opening and a full closing are connected in series. In parallel with this, a connecting pipe to which an R capillary tube 129, an R evaporator 114 and an accumulator 131 are connected as well as a connecting pipe to which an F capillary tube 130, an F evaporator 116 and an accumulator 132 and a check valve 133 are connected are connected in parallel.

The switch valve 126 is provided with a function of switching between an F flow passage through which a refrigerant is supplied to the connecting pipe to which the F, capillary tube 130, the F evaporator 116, the accumulator 132 and the check valve 133 are connected as well as an R flow passage through which the refrigerant is supplied to the connecting pipe to which the R capillary tube 129, the R evaporator 114 and the accumulator 131 are connected. Inflammable refrigerants (e.g. HC refrigerants) are used as the refrigerant described above.

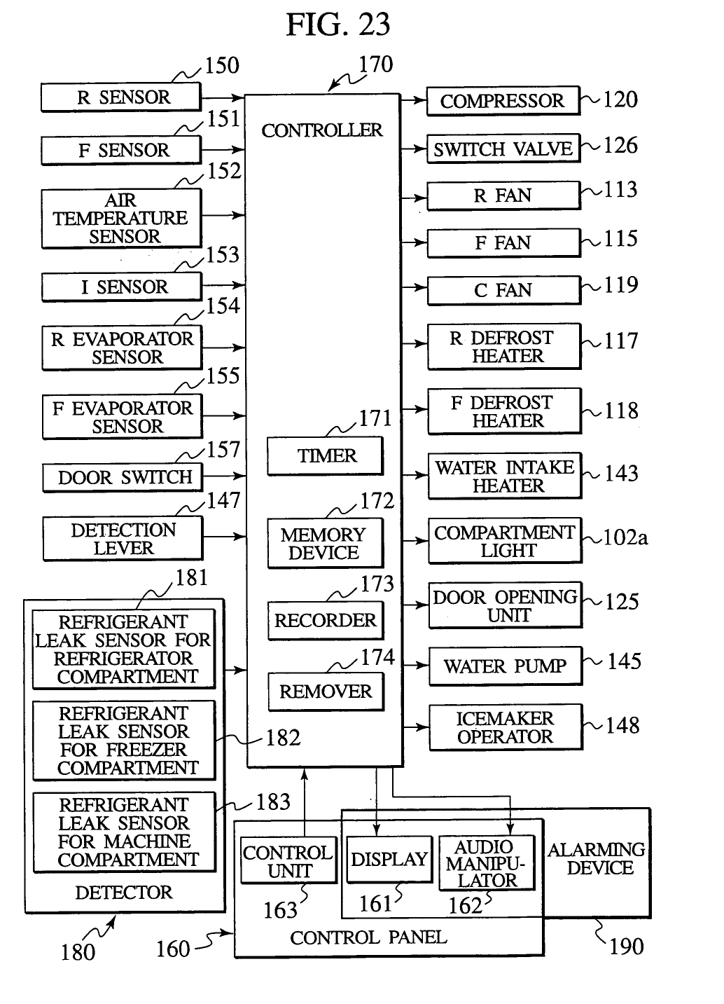

As shown in FIG. 23, a controller 170 receives signals outputted from a control unit 163 and a door switch 157, as well as signals regarding temperatures each detected by an R sensor 150 for detecting the temperatures in the refrigerator compartment 102 and the vegetable storage compartment 103, an F sensor 151 for detecting the temperature in the freezer compartment 105, an air temperature sensor 152 for detecting the temperature outside the compartments, an R evaporator sensor 154 for detecting the temperature of the R evaporator 114 and an F evaporator sensor 155 for detecting the temperature of the F evaporator 116.

The controller 170 causes the following to operate: a display 161, an audio manipulator 162, the compressor 120, the switch valve 126, the R fan 113, the F fan 115, the C fan 119, the R defrost heater 117, the F defrost heater 118, the automatic icemaker 141, the compartment light 102a and the door opening unit 125. Out of these, the compressor 120, the R fan 113, the F fan 115 and the C fan 119 each are caused to operate with variable speeds by an inverter circuit built in the controller 170.

In addition, the controller 170 is provided with memory devices 172 and recorders 173. The memory device 172 records information regarding operating conditions and the like of the refrigerator, and holds the recorded information even if the power supply is turned off. The memory device 172 is constructed of a non-volatile memory (e.g. an EEPROM) or the like. The recorder 173 places information regarding the operating conditions and the like of the refrigerator into the memory device 172.

In the above described refrigerator, when a refrigerating/cooling operation of cooling the refrigerator compartment 102 (i.e. the R flow passage operation) is performed, the controller 170 switches the switch valve 126 to the above described R flow passage, and concurrently causes the R fan 113 and the C fan 119 to operate. Hereby, a refrigerant that has been compressed into high temperature and pressure gas by the compressor 120 is sent to the condenser 127, and therein turns into liquid form while dissipating the heat. Hereafter, the refrigerant is sent to the R evaporator 114 through the switch valve 126 and the R capillary tube 129. Then, the refrigerant liquid vaporizes in the R evaporator 114, and absorbs the heat from the surroundings. In accordance with this, the air around the R evaporator 114 is cooled, and the cold air thus cooled is supplied to the refrigerator compartment 102 by a blowing operation of the R fan 113, and hereafter cools each compartment. In addition, the R fan 113 is also caused to operate in the course of a freezing/cooling operation (i.e. the F flow passage operation), and facilitates the defrosting of frost covering the R evaporator 114. The defrosting vaporizes or liquefies the frost, and cold air produced at this time is circulated into the refrigerator compartment 102. Accordingly, the humidity in the refrigerator compartment 102 rises.

On the other hand, when a freezing/cooling operation of cooling the freezer compartment 105 is performed, the controller 170 switches the switch valve 126 to the above described F flow passage, and concurrently causes the F fan 115 and the C fan 119 to operate. Hereby, a refrigerant that has been compressed into high temperature and pressure gas by the compressor 120 is sent to the condenser 127, and therein turns into liquid form while dissipating the heat. Hereafter, the refrigerant is sent to the F evaporator 116 through the switch valve 126 and the F capillary tube 130. Then, the refrigerant liquid vaporizes in the F evaporator 116, and the air around the F evaporator 116 is cooled. The cold air thus cooled is supplied to the freezer compartment 105 by a blowing operation of the F fan 115, and hereafter cools each compartment.

Furthermore, an operation of defrosting the F evaporator 116 is performed as follows. The controller 170 switched the switch valve 126, and hereby shuts off a flow of the refrigerant to the R evaporator 114 and the F evaporator 116, when a freezing/cooling operation is completed after time for which the compressor 120 has been operated reaches a prescribed amount of accumulated operating time. Hereafter, the refrigerant is recovered from the low pressure area including the evaporator by causing the compressor 120 for a prescribed length of time. Then, the controller 170 sends electric current to the F defrost heater 118, and starts to defrost the F evaporator 116. When the defrosting is completed, and when the temperature detected by the F evaporator sensor 155 reaches a prescribed temperature, the controller 170 turns off the electric current to the F defrost heater 118. Hereafter, the controller 170 switches the switch valve 126 to the F flow passage, and resumes a cooling operation. Incidentally, an operation of defrosting the R evaporator 114 sends electric current to the R defrost heater 117 and performs the defrosting operation, as in the case of an operation of defrosting the F defrost heater 116.

Next, an explanation will be given of a detector for detecting that a refrigerant leak has occurred in the refrigeration cycle or that a refrigerant is to leak in the refrigeration cycle.

The detector 180 comprises a refrigerant leak sensor 181 for the refrigerator compartment, a refrigerant leak sensor 182 for the freezer compartment, and a refrigerant leak sensor 183 for the machine compartment, all of which are intended to detect a refrigerant leak when the concentration of a refrigerant gas reaches a prescribed concentration. The refrigerant leak sensor 181 for the refrigerator compartment is arranged in the bottom of the vegetable storage compartment 103, and is intended to detect a refrigerant leak in a storage compartment in which the refrigerator compartment 102, the vegetable storage compartment 103 and the R evaporator 114 are arranged. The refrigerant leak sensor 182 for the freezer compartment is arranged in the bottom of the freezer compartment 105, and is intended to detect a refrigerant leak in a storage compartment in which the icemaker compartment 104, the multiple purpose compartment, the freezer compartment 105 and the F evaporator 116 are arranged. The refrigerant leak sensor 183 for the machine compartment is arranged in the bottom of the machine compartment 122, and is intended to detect a refrigerant leak in the machine compartment 122. Incidentally, places in which components of the detector 180 are arranged are not limited to the above-described places, for example. A refrigerant leak sensor may be arranged in each of the compartments.

Then, information detected by the detector 180 is outputted to the controller 170, and therein a recorder 173 places in the memory device 172 information regarding a refrigerant leak such as a fact that a refrigerant has leaked, an prediction that a refrigerant is to leak, a time and a place that the refrigerant has leaked/is to leak, an disorder of the refrigeration cycle, or the like.

It should be noted that the detector 180 may detect a disorder which is to occur in the refrigeration cycle in concurrence with a refrigerant leak which is to occur, instead of through the refrigerant leak sensors. For example, by detecting the difference in the temperature between the inlet and the outlet of the F evaporator 116 and fluctuations in the temperature, pressure, duties and the like of the compressor 120, it may be detected that a refrigerant has leaked or may be detected in advance that a refrigerant is to leak.

If a crack or a leak is to be caused in a joint of the pipes or the like in the high-pressure area, a refrigerant simultaneously leaks out of pipe because the refrigerant is high pressurized. Hereafter, a refrigerating performance goes lower, and hereby the difference in the temperature between the inlet and the outlet of the evaporator occurs. In addition, load cast on the compressor 120 decreases, and a tendency towards decreased temperature, pressure and duties lowered is noticed. In other words, in the high pressure area, if a crack or a leak is to be caused, the refrigerant leaks out. By finding such disorders in the refrigeration cycle, therefore, it can be detected that a refrigerant has leaked.

On the contrary, if a crack or a leak is to be caused in a joint of the pipes or the like in the low pressure area, the air is sucked into the pipes, since the refrigerant is low pressurized in the course of a refrigerating operation. For this reason, the performance of refrigeration by evaporator becomes lower, and accordingly the difference in the temperature between the inlet and the outlet of the evaporator appears. In addition, the compressor 51 comes to be overloaded, since the compressor 51 has sucked up the air. Accordingly a tendency towards increased temperature, pressure, and duties is noticed. In other words, in the low pressure area, it can be detected in advance that a refrigerant is to leak by finding the difference in the temperature between the inlet and the outlet of the evaporator, or the increased pressure and duties of the compressor 120 prior to the refrigerant leak which is to occur.

Next, an alarming device 190 will be described. The alarming device 190 is intended to give users an alarming signal warning against a refrigerant leak and to urge the users to cope with the refrigerant leak. The alarming device 190 is constituted of the display 161 and the audio manipulator 162 which have been arranged in the control panel 160. The display 161 is caused to give an alarming signal, such as a light, a blinker, words or the like, warning against an abnormal condition. The audio manipulator 162 is caused to gives an alarming signal, such as alarming sounds or an announcement, warning against an abnormal condition. In addition, the recorder 173 places in the memory device 172 a record regarding a fact that the alarming device 190 has been caused to operate.

It should be noted that the alarming device 190 serves for the object of the present invention if the alarming device 190 can urge users to cope with the refrigerant leak. Accordingly, the alarming device 190 is not limited to giving an alarming signal through the display 161 or the audio manipulator 162. For example, the alarming device may give an alarming signal through sending to users the alarming signal to a household terminal device or a cellular phone. Furthermore, the alarming device may appeal to the olfactory senses of users.

Next, an explanation will be given of fluctuations, in the concentration of a leaked refrigerant gas, which vary with the lapse of time if a refrigerant leak is to occur in the refrigeration cycle.

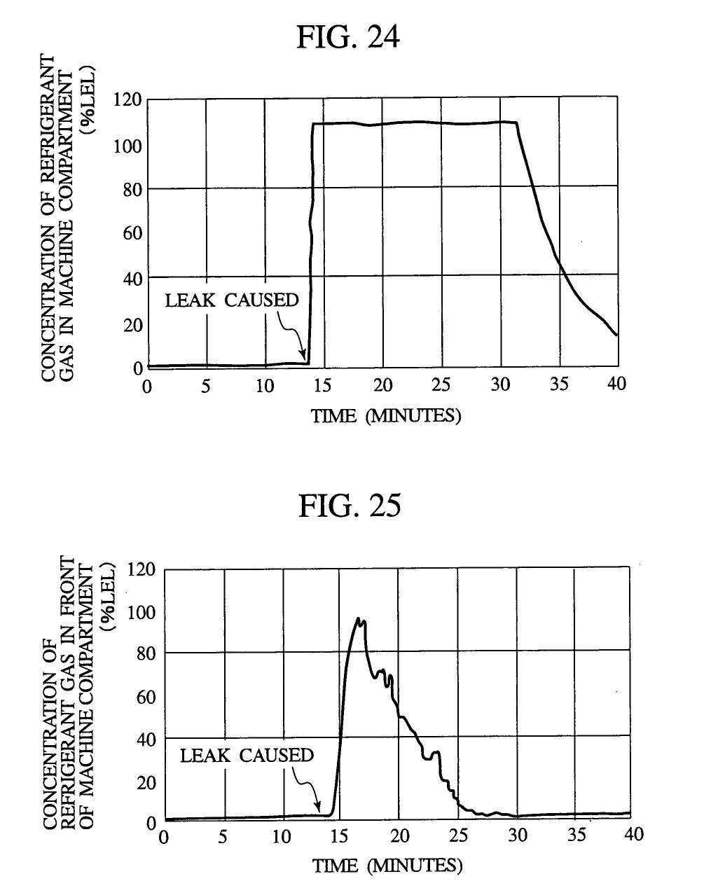

FIG. 24 shows fluctuations in the concentration of the leaked refrigerant gas in the machine compartment 122 under the following conditions. 50.5 grams of an HC refrigerant had been poured into the refrigeration cycle, and was sealed off. Then, a leak of φ 1.0 was made in the pipe on the side of the outlet of the compressor 120 while a usual refrigerating operation was performed. The axis of abscissas represents time (denominated with minutes). The axis of ordinates represents the concentration of the refrigerant gas in terms of percentage with the lowest concentration of ignition (LEL) defined as an index of 100. The LEL of the HC refrigerant is 1.8% vol. Specifically, when the concentration of the refrigerant gas is equal to, more than, 100% of the LEL, the concentration of the refrigerant gas is equivalent to the concentration of ignition. When the concentration of the refrigerant gas is lower than 100% of the LEL, the refrigerant gas is not ignited. FIG. 25 shows fluctuations in the concentration of the leaked refrigerant gas in the vicinity of the front bottom of the main body 101 of the refrigerator in a similar experiment.

As shown in FIG. 24, a leak was made in the pipe on the side of the outlet of the compressor 120 when 14 minutes have passed. By this, a refrigerant leaked out of the pipe in a fraction of time, and the concentration in the machine compartment 122 soared up to be more than 100% of the LEL. A state that a risk of ignition was therein appeared.

At this time, the refrigerant continued leaking out of the pipe, and the concentration of the refrigerant gas continued to be more than 100% of the LEL awhile. Thereafter, the refrigerant gas diffused via the air inlet and outlet of the machine compartment 122 to the outside of the compartment through the natural circulatory motion of the air. After 30 minutes have passed, the concentration of the refrigerant gas gradually decreased. After 32 minutes have passed, the concentration of the refrigerant gas came to be lower than 100% of the LEL, and accordingly the machine compartment 122 came into such a state that no risk of ignition was therein.

In addition, as shown in FIG. 25, the concentration of the refrigerant gas soared up in the vicinity of the front bottom of the main body 101 of the refrigerator in a fraction of time, when the refrigerant leak was occurred after the 14 minutes have passed. Since, however, the refrigerant gas diffused into the air, the concentration of the refrigerant gas in the front bottom of the main body 101 of the refrigerator was lower than that in the machine compartment 122, and the front bottom of the main body 101 was safer. When 25 minutes have passed, the concentration of the refrigerant gas came to be lower than 10% of the LEL. Accordingly, the front bottom of the main body 101 of the refrigerator came into such a state that no risk of ignition was surely therein.

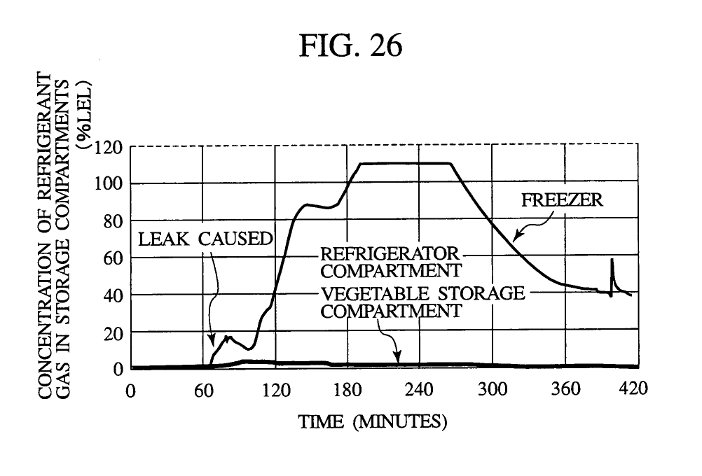

FIG. 26 shows fluctuations in the concentration of the leaked refrigerant gas in the freezer compartment 105 under the following conditions. 50.5 grams of an HC refrigerant had been poured into the refrigeration cycle, and was sealed off. Then, a leak of φ 0.1 was made in the connecting pipe of the F evaporator 116 while an F refrigerating operation was performed.

The reason why the leak for this experiment was made smaller than that for the experiment with the machine compartment 122 is that a refrigerant leak, which is to occur in a real situation, was simulated. The real situation is as follows: the refrigeration cycle in the compartment is low pressurized, and accordingly the refrigerant leak from the connecting pipe progresses slowly.

As shown in FIG. 26, a leak was made when 70 minutes have passed. By this, a refrigerant gradually leaked out of the pipe, and the concentration of the refrigerant gas increased. When 185 minutes have passed, the concentration of the refrigerant gas reached 100% of the LEL, and a state that a risk of ignition was therein appeared. When 275 minutes have passed, however, the refrigerant gas diffused out of the compartment through the drainpipes 124a and 124b as well as gaps in the gaskets of the door 109, and the concentration of the refrigerant gas decreased later.

After 280 minutes have passed, the concentration of the refrigerant gas came to be lower than 100% of the LEL, and a risk of ignition in the compartment disappeared. Of course, in the vicinity of the main body 101 of the refrigerator and in the machine compartment 122, the refrigerant gas diffused into the air, and accordingly the concentration of the refrigerant gas showed almost no increase. In addition, the flows of cold air in the refrigerator compartment 102 and the vegetable storage compartment 103 were independent of the flow of cold air in the compartment, and the concentrations of the refrigerant gas in the two proceeding compartments did not increase, and the safety was ensured in the two compartments.

To sum up, as is evident from FIG. 24, FIG. 25 and FIG. 26, when a prescribed length of time has passed after the leak was made, the refrigerant gas diffuses out of the main body of the refrigerant into the air, and accordingly no inflammation was caused in the compartments and in the vicinity of the main body of the refrigerator. As a result, the compartments and the vicinity of the main body of the refrigerator return to a safe state.

(Processing 1 for an Operation of an Alarming Device)

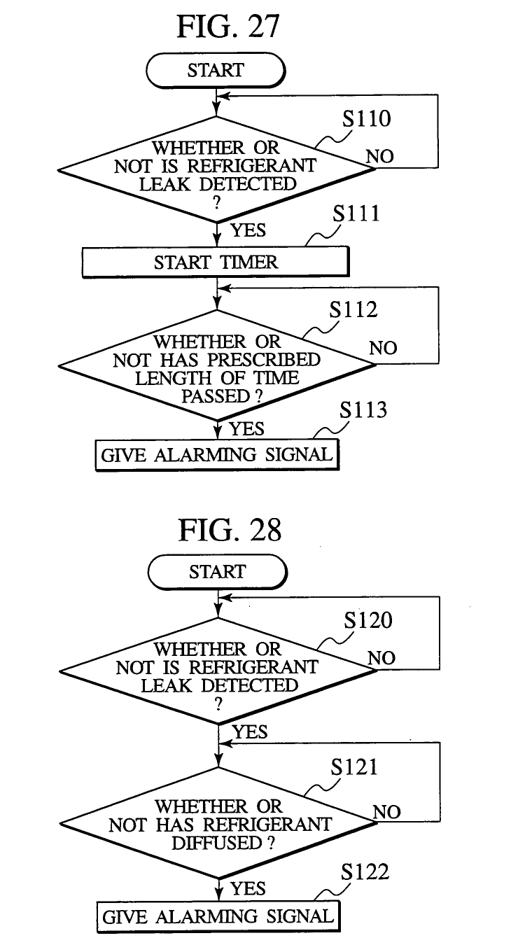

Next, an explanation will be given of timings of an operation of the alarming device 190. As shown in FIG. 27, the detector 180 always detects a refrigerant leak, and finds that a refrigerant is to leak, or that a refrigerant has leaked (S110). In the case that the detector 180 has not found a refrigerant leak, the detector 180 continues searching for a refrigerant leak. In the case that the detector 180 has found a refrigerant leak, the detector 180 causes a timer 171 built in the controller 170 to operate to measure time (S111).

It takes a certain length of time (300 minutes) for the concentration of the refrigerant gas, which has leaked out of the compartments, to come to be at least lower than the concentration of inflammation through the diffusion out of the compartments. This certain length of time is defined as a prescribed length of time. When the prescribed length of time has passed, the controller 170 causes the alarming device 190 to operate (S112 and S113).

A refrigerant leak in a compartment has been thought of here. Since it takes long for the compartment to return to a safe state in this case, the prescribed length of time has been defined as 300 minutes with reference to FIG. 26. The preferable prescribed length of time varies, however, depending on an amount of a refrigerant to be poured and sealed off, a constitution of the refrigeration cycle and an amount of air to be circulated. For this reason, it is preferable that the prescribed length of time is adjusted according to the constitution of the refrigerator.

When a refrigerant leak is detected in the machine compartment 122 by the refrigerant leak sensor 183 for the machine compartment, it takes a shorter length of time for the machine compartment 122 to return to a safe state than it takes for the compartments. For this reason, the prescribed length of time may be defined as 30 minutes with reference to FIG. 24.

Otherwise, the prescribed length of time may be chosen depending on whether a refrigerant leak is detected in the compartments or in the machine compartment. Specifically, when the refrigerant leak sensor 181 for the refrigerator compartment or the refrigerant leak sensor 182 for the freezer compartment detects a refrigerant leak, the prescribed length of time is defined as 300 minutes. When the refrigerant leak sensor 183 for the machine compartment detects a refrigerant leak, the prescribed length of time is defined as 300 minutes.

With regard to the above-described constitution, an alarming signal is given after a safe state returns. When a refrigerant leak, which is to occur, makes the concentration of the refrigerant gas in the compartments and in the vicinity of the refrigerator so high that a risk of ignition is also high, this constitution does not have users come close to the refrigerator with giving an unnecessary alarming signal. Accordingly, a source of ignition is prevented from being carried nearby.

Moreover, when an alarming device is caused to operate, it is likely that users feel so upset that the users operate the control panel and the like. Even if the operation of the control panel unexpectedly generates sparks at a contact point, a possibility of ignition caused by electrical components can be reduced, since the leaked refrigerant which was in the compartments and in the vicinity of the main body of the refrigerator has already diffused.

(Processing 2 for an Operation of an Alarming Device)

Next, an explanation will be given of other timings of an operation of the alarming device 190. As shown in FIG. 28, the detector 180 similarly detects that a refrigerant is to leak, or that a refrigerant has leaked (S120).

After a refrigerant has leaked out of the refrigeration cycle completely, the concentration of the refrigerant gas gradually decreases. For this reason, if the detector 180 is caused to be operating uninterruptedly, the detector ceases to search for a refrigerant leak because of the decreased concentration of the refrigerant gas. With this taken into consideration, the detector 180 is caused to be checking uninterruptedly whether or not the refrigerant has diffused (S121). When the detector ceases to detect a refrigerant leak, the detector 180 determines that a refrigerant gas so diffuses into the air in the compartments and in the vicinity of the refrigerator that a safe state returns, and hereafter causes the alarming device 190 to operate.

If the alarming device is caused to operate after the refrigerant leak ceases to be detected in this way, a degree of the safety can be further increased, since the concentration of the refrigerant gas is surely lower than the concentration of ignition when an alarming device is caused to operate against any form of refrigerant leak.

Moreover, the concentration of the refrigerant that causes the detector to find a refrigerant leak is defined as 10% of the LEL. The concentration of the refrigerant that causes the detector to determine whether or not the refrigerant has been diffused is defined as 80% of the LEL. Changing in the detected concentrations for the acts of detection, the detection of, and the giving an alarming signal warning against a refrigerant leak can be performed promptly.

(Processing 3 for an Operation of an Alarming Device)

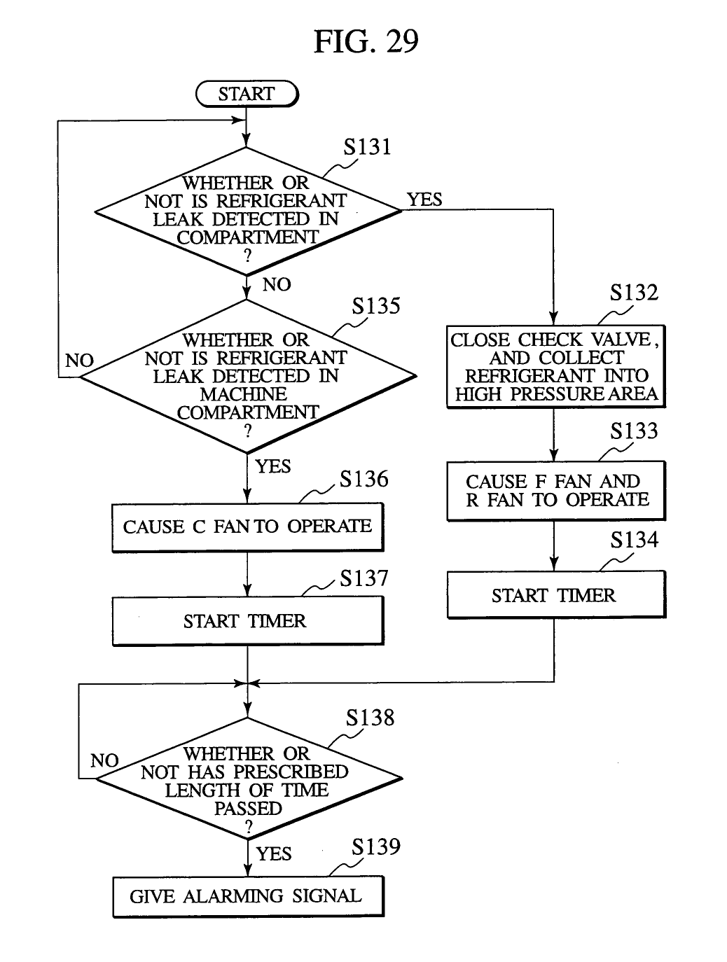

Next, an explanation will be given of yet other timings of an operation of the alarming device 190. As shown in FIG. 29, the refrigerant leak sensor 181 for the refrigerator compartment or the refrigerant leak sensor 182 for the freezer compartment detects that a refrigerant is to leak in the compartments or that a refrigerant has leaked in the compartments (S131). If neither the refrigerant leak sensors 181 nor 182 detect a refrigerant leak, the refrigerant leak sensor 183 for the machine compartment instead detects whether or not a refrigerant has leaked in the machine compartment (S135).

If a refrigerant leak is to be detected in one of the compartments in the step S131, it means that the refrigerant leaks from a pipe in the low pressure area such as the R evaporator 114, the F evaporator 116 and the like which are exposed to the respective compartments. The controller 170 does the following things in order to minimize the refrigerant leak in the compartment by collecting the refrigerant in the pipes in the low-pressure area into the pipes in the high pressure area. The controller 170 causes the switch valve 126 to close fully, and causes the compressor 120 to operate for a prescribed length of time, for example 90 seconds. Hereby, the controller 170 collects the refrigerant into the high-pressure area of the refrigeration cycle (specifically the switch valve 126 and the compressor 120)(S132).

After the refrigerant gas has been collected, it is likely that part of the leaked refrigerant gas still remains in the compartment. Since the refrigerant gas is heavier than the air, the refrigerant gas accumulates in the bottom of the compartment, and accordingly the concentration becomes higher. To prevent this, the F fan 115 and the R fan 113 are caused to operate. As a measure against the refrigerant leak, the F fan 115 and the R fan 113 circulate, and diffuse, the air in the compartment in order to prevent the refrigerant gas from accumulating in a part of the bottom or the like in the compartment, and accordingly to prevent the concentration of the refrigerant gas from coming to be higher than the concentration of ignition (S133). It is preferable that the F fan 115 and the R fan 113 are constructed explosion-proofed in a way that the air in the compartments does not flow into the interior of the motors of the fans, and the like. Instead, it is also preferable that brush-less motors that do not include contact points that cause sparks are used for the fans.

In addition, the timer 171 is caused to operate to measure the time (S134). Incidentally, the operation of the timer 171 may be started when the refrigerant leak is detected in the compartment in the step S131.

On the other hand, if a refrigerant leak is to be detected in the machine compartment 122 in the step S135, the controller 170 causes the C fan 119 to operate in order to diffuse the refrigerant gas out of the machine compartment 122 quickly (S136). This is because the air intake and outlet of the machine compartment 122 communicate with the outside of the compartment. This enables the refrigerant gas to be discharged from the compartment quickly and to be diffused into the air. Accordingly, the concentration of the refrigerant quickly comes to be lower than the concentration of ignition. As a result, the surroundings of the machine compartment 122 returns to a safe state. In this regard, it is preferable that the C fan 119 is also constructed explosion-proofed in a way that the air in the compartments does not flow into the interior of the motors of fans and the like. Instead, it is also preferable that brush-less motors that do not include contact points that cause sparks are used for the fan.

If the C fan 119 is caused to operate in the step S136, the timer 171 is caused to operate to measure the time (S134). Incidentally, the operation of the timer 171 may be started when a refrigerant has been detected in the compartment in the step S135.

Subsequently, the controller 170 determines, based on the below described time measurements, whether or not the concentration of the refrigerant has come to be lower than the concentration of ignition in the compartments and in the vicinity of the refrigerator, or whether or not accordingly the compartments and the vicinity of the refrigerator return to a safe state (S138). With regard to a refrigerant leak that is to be detected in the compartments in the step 131, the controller 170 determines whether or not the time measured by the timer 171 has exceeded 300 minutes, for example. With regard to a refrigerant leak that is to be detected in the machine compartment in the step S135, the controller 170 determines whether or not the time measured by the timer 171 has exceeded 30 minutes for example. When the controller 170 determines that the prescribed length of time has passed, and that accordingly a safe state has returned, the controller 170 causes the alarming device 190 to operate and let users informed of it (S139).

Since this configuration has already completed taking measures against a refrigerant leak for reducing the concentration of the refrigerant, such as collecting the refrigerant, diffusing the refrigerant, halting irrelevant operations by electrical components, an unsafe state can be avoided quickly, even if users feel so uncomfortable with the operation by the alarming device 190 that the users turns off the power supply. Accordingly, a degree of the safety could be improved.

It should be noted that, as measures against a refrigerant leak, the below described procedures for precluding the electrical components from causing sparks at a contact point are desired in addition to causing the fans to operate. Even if the control unit 163 is operated, it should be designed not to cause the R defrost heater 117, the F defrost heater 118, the deodorizer 123, the water pump 145, the icemaker operator 148. Operations by the switch valve 126, the compressor 120 and the like should be halted in steps following especially the step S133.

It is preferable that the compartment light 102a and the door opening unit 125 are turned off after the step 139 for causing the alarming device 190 to operate has been completed. The reason for this is as follows. If the compartment light 102a or the door opening unit 125 is not caused to operate, it is likely that this has users make a wrong judgment that the refrigerator is out of order and unexpectedly hinder the measure against the refrigerant leak by doing things such as turning off the power supply.

(Processing 4 for an Operation of an Alarming Device)

Next, an explanation will be given of still other timings of an operation of the alarming device 190. This section will describe, controls to be exercised after the power supply is once turned off or reset and thereafter turned on or reset again

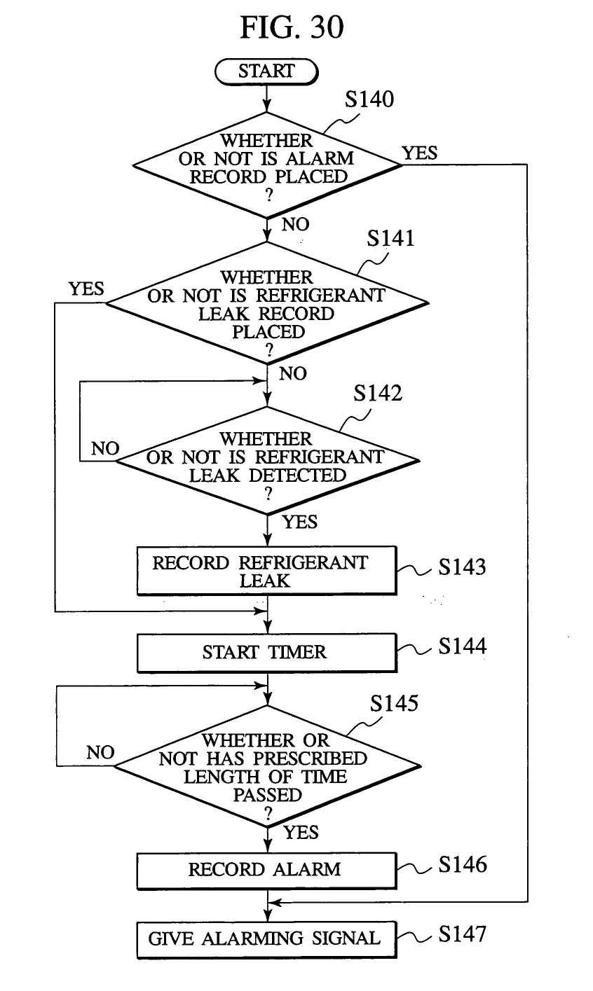

As shown in FIG. 30, the controller 170 determines, at first, whether or not an alarm record regarding an operation of the alarming device 190 is placed in the memory device 172 (S140). If the alarm record is not placed in the memory device 172, the controller 170 determines whether or not information regarding a refrigerant leak such as a fact that a refrigerant has leaked or a prediction that a refrigerant is to leak is placed in the memory device 172 (S141). If the record regarding a refrigerant leak is not placed in the memory device 172, the controller 170 determines that a refrigerant leak had not occurred before the power supply was turned off or reset, and hereafter determines, in a usual procedure through the detector 180, whether or not a refrigerant is to leak or whether or not a refrigerant has leaked (S142).

If a refrigerant leak is not detected in the step S142, the controller 180 continues searching for a refrigeration leak. When the controller 180 detects a refrigerant leak, the controller 180 outputs the information regarding the refrigerant leak to controller 170, causes the recorder 173 to place the record regarding the refrigerant leak in the memory device 172 (S143), and causes the timer 171 to operate (S144).

Subsequently, the controller 170 determines whether or not the time measured by the timer 171 has exceeded the prescribed length of time (S145). If the prescribed length of time has passed, the controller causes the recorder 173 to place the alarm record in the memory device 172 (S146), and causes the alarm device 190 to operate (S147).

On the other hand, in the case that a record regarding a refrigerant leak is being placed in the memory device 172 in the step S141, it means that the refrigerant leak has been already detected, and that the controller 170 has caused the timer 171 to measure the time, before the power supply to the refrigerator was turned off or reset.

To sum up, it is likely that the concentration of the refrigerant is higher than the concentration of ignition in the compartments and in the vicinity of the main body 101 of the refrigerator since the refrigerant leak has occurred. For this reason, it is dangerous to cause the refrigerator to give an alarming signal, and to cause the refrigerator to perform a usual refrigerating operation. With this taken into consideration, the controller 170 causes the refrigerator to perform no usual refrigerating operation, and instead takes measures against the refrigerant leak such as causes the fans to diffuse the refrigerant, causes irrelevant electrical components to halt, and does other things. Hereafter, the controller 170 proceeds to the step S144. Hereby, the refrigerator returns to a previous state which existed before the power supply was turned off or reset.

With regard to the measurement of time by the timer 171, the measurement may start with an initial value, and may instead resume with the time that had been measured until the power supply to the refrigerator was turned off or reset.

In addition, if an alarm record is being placed in the memory device 172 in the step S140, it means that the leaked refrigerant so diffused that there was no risk of ignition, and that accordingly a safe state returned, before the power supply to the refrigerator was turned off or reset.

Nevertheless, causes of the refrigerant leak have not been removed. If a usual refrigerating operation is performed while in such a state, more refrigerant leaks. For this reason, a normal operation cannot be performed. Against this background, if an alarm record is being placed in the memory device 172, the controller 170 directly proceeds to the step S147, and hereby causes the alarming device 190 to operate and give users an alarming signal to let users know the refrigerant leak and the halted operation of the refrigerator, and to urge users to have the refrigerator fixed.

Even if a power failure happens or users turn off the power supply in the case that a refrigerant leak occurs, this configuration could give an alarming signal after the configuration makes certain, following the resumption of the power supply, that the concentration of the refrigerant gas has come to be lower than the concentration of ignition. Accordingly, a degree of the safety could be improved.

In addition, even if a power failure happens or users turn off the power supply while the alarming device 190 is being caused to operate, this configuration would enable the alarming device 190 to operate immediately after the power supply is turned on again. As a consequence, this configuration could urge users to have the refrigerator fixed quickly.

A record regarding a refrigerant leak and an alarm record are configured to be removed from the memory device 172 by a remover 174 when users operate the control unit 163.

It should be noted that, when a record regarding a refrigerant leak and an alarm record remain in the memory device 172, a usual refrigerating operation is not resumed, even if the refrigerator has been fixed on the refrigerant leak and is in normal operating conditions. To cope with this, a flag for managing measures against a refrigerant leak and an operation of the alarming device is placed in the memory device 172. When the refrigerator returns to normal operating conditions, this flag is removed from the memory device 172. By this, the refrigerator is caused to work in normal conditions. For this reason, a control board on which the controller 170 for controlling operations of the refrigerator is mounted need not be replaced or done away with. This contributes to recycling of natural resources, and repairing costs can be reduced.

The above-described configuration is just for an explanation of an embodiment of the present invention. Modifications and combinations are possible as long as these modifications and combinations do not depart from the spirit and the scope of the present invention. In addition, it goes without saying that a detector, measures against a refrigerant leak, the setting up of the prescribed length of time should be most suitable for a preferable embodiment of the refrigerator.

### Industrial Applicability

A first mode of refrigerator is configured to cause the above described alarming device to stop giving an alarming signal after doors are opened following the occurrence of a refrigerant leak. Giving an alarming signal is designed to be stopped only when doors are opened. Even if, therefore, users feel uncomfortable with an alarming signal such as a buzzer, a voiced instruction, a display or the like from a control panel, users have to open doors even though the users feel annoyed. Since doors are surely opened, a refrigerant gas diffuses into the air without suffusing compartments. For this reason, the concentration of the diffused refrigerant gas comes to be lower than the concentration of inflammation. Even if a source of ignition is outside the compartments, the refrigerant gas is not inflamed. Accordingly, a degree of the safety could be improved.

The refrigerator is configured to cause the alarming device to stop giving an alarming signal after all the doors of the storage compartments are opened. By this, a refrigerant gas can be prevented from suffusing the compartments, and can be diffused into the air quickly, even if one of the storage compartments tends to be suffused with the refrigerant gas. Accordingly, a degree of the safety could be improved.

A second mode of refrigerator is configured to cause the alarming device to stop giving an alarming signal after the doors of the storage compartments into which cold air flows by causing the damper to open are opened. Users are allowed to do nothing but open doors which have to be opened, and the refrigerant gas can be caused to diffuse promptly and securely. In this case, if the control panel or the like can show which doors should be opened, this serves for the object of the present invention more effectively.

The refrigerator is configured to detect that a refrigerant has leaked in a compartment, or to detect in advance that a refrigerant is to leak. By this, the refrigerant gas can be surely prevented from suffusing a compartment. Accordingly, a degree of the safety could be improved.

A third mode of refrigerator is configured to cause the above described alarming device to stop giving an alarming signal after the door of a storage compartment in a refrigerating space or a freezing space in which a refrigerant leak has been detected are opened. If a refrigerant leak is to occur in one of the refrigerating space and the freezing space, therefore, the door of one space which the refrigerant gas does not suffuse because of no flow of cold air therein need not be opened. Accordingly, users are allowed to do nothing but open doors which have to be opened, the refrigerant gas can be caused to diffuse promptly and securely. In this case, if the control panel or the like can show which doors should be opened, this serves for the object of the present invention more effectively.

The refrigerator is configured to cause the alarming device to stop giving an alarming signal after the door has been left open longer than a prescribed length of time. Since, therefore, the door is left open longer than the prescribed length of time by users, the refrigerant gas is diffused into the air without suffusing the compartment. The concentration of the diffused refrigerant gas comes to be lower than the concentration of inflammation. For this reason, even if a source of ignition is outside the compartments, the refrigerant gas is not inflamed. Accordingly, a degree of the safety could be improved.

The refrigerator is configured as follows. After the alarming device is caused to stop giving an alarming signal following the opening of the door, the alarming device is caused to give an alarming signal again, if the door is closed although the door has been left open shorter than the prescribed length of time. If the door is closed after time for which the door has been left open exceeds the prescribed length of time, the alarming device continues giving no alarming signal. If the time for which the door has been left open is shorter, the refrigerant gas that has suffused the compartment can not be diffused fully. If the door is closed although the time for which the door has been left open is shorter than the prescribed length of time, the alarming device is caused to give an alarming signal again. In this way, users are urged to keep the door open longer than the prescribed length of time. Accordingly, a degree of the safety could be improved.

The refrigerator is provided with an auxiliary power supply for causing the alarming device to continue giving an alarming signal in the case that the power supply is turned off. Even if users feel so upset with an alarming signal as to turn off the power supply, the alarming device continues giving an alarming signal to users, and hereby urges users to keep the door open. In this way, the refrigerant gas can be surely diffused out of the compartment. Accordingly, a degree of the safety could be improved.

The refrigerator is configured to cause the alarming device to resume giving an alarming signal in the case that the power supply is turned on again after the power supply was turned off while the alarming device was giving an alarming signal. Even if users feel so upset with an alarming signal as to turn off the power supply, the alarming device resumes giving an alarming signal if the power supply is turned on again, and hereby urges users to keep the door open. In this way, the refrigerant gas can be surely diffused out of the compartment. Accordingly, a degree of the safety could be improved.

A fourth mode of refrigerator is configured to cause an alarming signal warning against a refrigerant leak to be given when a prescribed length of time has passed after the refrigerant leak was detected. While, therefore, a high risk of ignition exists in a compartment or in the vicinity of the refrigerator after a refrigerant leak has occurred, giving an alarming signal prevents users from coming close to the refrigerator. Accordingly, a risk of ignition could be reduced.

The refrigerator is configured so that the prescribed length of time is defined as a time which it takes for the concentration of the refrigerant to come to be lower than the concentration of inflammation. Even if users feel so upset with an alarming signal as to operate the control panel so that sparks are unexpectedly caused at a contact point, the refrigerant which has suffused in the compartment and in the vicinity of the refrigerator is now diffused. Accordingly, possibilities of ignition through electrical components and the like, therefore, could be reduced.

A fifth mode of refrigerator is configured to cause an alarming signal to be given after the refrigerant is so diffused that the refrigerant leak is no longer detected in the case that the refrigerant leak is detected. When the alarming device is caused to operate, the concentration of the leaked refrigerant is surely lower than the concentration of ignition. Accordingly, a degree of the safety could be improved.

The refrigerator is configured to complete taking measures against a refrigerant leak from a time when the refrigerant leak is detected through a time when an alarming signal is given. Even if, therefore, users feel so uncomfortable with an alarming signal as to turn off the power supply, the collecting of the refrigerant, the turning off the power supply to irrelevant electrical components, the control against the refrigerant leak for reducing the concentration of the leaked refrigerant has been completed before the alarming signal is given. For this reason, a state that there is a possibility of ignition could be avoided. Accordingly, a degree of the safety could be improved.

The refrigerator is configured to cause the alarming device to give an alarming signal when the prescribed length of time has passed after the power supply is turned on in the case that a record regarding a refrigerant leak is already placed in the memory device when the power supply is turned on. Even if the concentration of the leaked refrigerant is so high that there is a dangerous state when the power supply is turned on, an alarming signal is given when the prescribe length of time has passed after the power supply is turned on. Accordingly, even if users turn off the power supply, a degree of the safety could be improved.

The refrigerator is configured to cause the alarming device to start giving an alarming signal when the power supply is turned on in the case that an alarm record is placed in the memory device when the power supply is turned on. In the case that users turn off, and on again, the power supply while the alarming device is being caused to operate, the alarming device is immediately caused to operate. Accordingly, users can be quickly informed of the refrigerant leak and the necessity for the repair, and users can be surely urged to take action for following up the repair.

The refrigerator is configured to be capable of removing a record regarding a refrigerant leak or an alarm record. After the refrigerator is fixed on the refrigerant leak and the like, the controller can cause the refrigerator to operate in normal conditions. Accordingly, the control board on which the controller is mounted need not be replaced or done away with. This contributes to recycling of natural resources, and repairing costs can be reduced.

1. A refrigerator comprising:
a refrigeration cycle which a compressor, a condenser, a capillary, an evaporator, and an accumulator are connected to, and in which an inflammable refrigerant is included;
a detector for detecting a leak of the refrigerant;
an alarming device for giving an alarming signal warning against the refrigerant leak when the refrigerant leak is detected by the detector; and
a controller for causing the alarming device to stop giving an alarming signal after a door of a storage compartment is opened.

2. The refrigerator according to claim 1, wherein the alarming device is caused to stop giving an alarming signal after all the doors are opened.

3. A refrigerator comprising:
a refrigeration cycle which a compressor, a condenser, a capillary, an evaporator, and an accumulator are connected to, and in which an inflammable refrigerant is included;
a duct for sending cold air which has been cooled by the evaporator to at least the storage compartments including a refrigerator compartment and a freezer compartment;
a damper, which is arranged in the duct, for adjusting an amount of the cold air which is being sent;
a detector for detecting a leak of the refrigerant;
an alarming device for giving an alarming signal warning against the refrigerant leak when the refrigerant leak is detected by the detector; and
a controller for causing the alarming device to stop giving an alarming signal after a door of a storage compartment into which the cold air flows after the damper is opened.

4. The refrigerator according to claim 1, wherein the detector detects a refrigerant leak in the compartment.

5. A refrigerator comprising;
a refrigerating space and a freezing space which are formed in a way that the storage space in the main body of the refrigerator is sectioned off by a partition wall;
a refrigeration cycle which a compressor, a condenser, capillaries and evaporators for the refrigerating space and the freezing space, and an accumulator are connected to in a way that the refrigerating space and the freezing space are capable of being controlled independently for refrigeration, and in which an inflammable refrigerant is included;
a detector for detecting a refrigerant leak in each of the refrigerating space and the freezing space;
an alarming device for giving an alarming signal warning against the refrigerant leak when the refrigerant leak is detected by the detector; and
a controller for causing the alarming device to stop giving an alarming signal after a door of a compartment in one of the refrigerating space and the freezing compartment in which the refrigerant leak is detected by the detector is opened.

6. The refrigerator according to claim 1, wherein the alarming device is caused to stop giving an alarming signal after the door is left open longer than a prescribed length of time.

7. The refrigerator according to claim 1, wherein, after the door is opened and the alarming device is caused to stop giving an alarming signal, the alarming device is caused to give an alarming signal again in the case that the door is closed while in the state that time for which the door has been left open is shorter than a prescribed length of time, or the alarming device is caused to continue giving no alarming signal in the case that the door is opened while in the state that time for which the door has been left open is longer than a prescribed length of time.

8. The refrigerator according to claim 1, further comprising an auxiliary power supply for causing the alarming device to continue giving an alarming signal in the case that the power supply is turned off.

9. The refrigerator according to claim 1, wherein, in the case that the power supply is turned off and again on while the alarming device is caused to be giving an alarming signal, the alarming device is caused to resume giving an alarming signal.

10. A refrigerator comprising:
a refrigeration cycle which a compressor, a condenser, a capillary, an evaporator, and an accumulator are connected to, and in which an inflammable refrigerant is included;
a detector for detecting a leak of the refrigerant;
an alarming device for giving an alarming signal warning against the refrigerant leak after a prescribed length of time has passed in the case that the refrigerant leak is detected by the detector.

11. The refrigerator according to claim 10, wherein a described length of time is defined as a time which it takes for the concentration of the refrigerant to come to be lower than the concentration of inflammation while the leaked refrigerant diffuses out of a compartment.

12. A refrigerator comprising:
a refrigeration cycle which a compressor, a condenser, a capillary, an evaporator, and an accumulator are connected to, and in which an inflammable refrigerant is included;
a detector for detecting a leak of the refrigerant;
an alarming device for giving an alarming signal warning against the refrigerant leak when a refrigerant leak is no longer detected after the refrigerant diffuses in the case that the refrigerant leak is detected by the detector.

13. The refrigerator according to claim 10, wherein control for taking action against the refrigerant leak is performed from a time when the detector detects the refrigerant leak through a time when the alarming device is caused to give an alarming signal.

14. The refrigerator according to claim 10, further comprising a memory device for memorizing a record regarding a refrigerant leak when the refrigerant leak is detected by the detector, and hold the record regarding the refrigerant leak even though the power supply is turned off,
wherein the alarming device is caused to give an alarming signal after a prescribed length of time has passed following the turning on of the power supply in the case that the record regarding the refrigerant leak is being placed in the memory device when the power supply is turned on.

15. The refrigerator according to claim 14, wherein the memory device can remove the record regarding the refrigerant leak.

16. The refrigerator according to claim 10, further comprising a memory device for memorizing an alarm record when the alarming device is caused to give an alarming signal, and hold the alarm record even though the power supply is turned off,
wherein the alarming device is caused to start giving an alarming signal when the power supply is turned on in the case that the alarm record is being placed in the memory device when the power supply is turned on.

17. The refrigerator according to claim 16, wherein the memory device can remove the alarm record.

18. The refrigerator according to claim 1, wherein the detector detects that a refrigerant has leaked, and the alarming device gives an alarming signal informing that the refrigerant has leaked.

19. The refrigerator according to claim 1, wherein the detector detects in advance that a refrigerant is to leak, and the alarming device is caused to give an alarming signal informing that the refrigerant is to leak.
